(19) United States
(12) Patent Application Publication
(10) Pub. No.: US 2014/0343893 A1
(43) Pub. Date: Nov. 20, 2014

(54) METROLOGICAL APPARATUS AND A METHOD OF DETERMINING A SURFACE CHARACTERISTIC OR CHARACTERISTICS

(71) Applicant: Taylor Hobson Limited, Leicester, Leicestershire (GB)

(72) Inventor: Daniel Mansfield, Leicester (GB)

(73) Assignee: Taylor Hobson Limited, Leicester, Leicestershire (GB)

(21) Appl. No.: 14/361,417

(22) PCT Filed: Nov. 28, 2012
(86) PCT No.: PCT/GB2012/052930

§ 371 Date: May 29, 2014

(30) Foreign Application Priority Data
Nov. 30, 2011 (GB) 1120604.2

(51) Int. Cl. G01B 11/30; G01B 11/24

(52) U.S. Cl. CPC G01B 11/30; G01B 11/2441
USPC 702/167

(57) ABSTRACT

A metrological apparatus has a surface data determiner to determine from measurement data a measured surface roughness data set (150) representing measured surface roughness and including any vibration induced measurement error and a harmonic model provider (120) providing a harmonic model representing vibration-induced surface characteristics of the surface as a set of harmonic components selected based on a surface form of the surface of the workpiece. A surface roughness determiner (140) uses the harmonic model and the measured surface roughness data to obtain a modified surface roughness data set in which vibration induced measurement error is suppressed.

This invention relates to metrological apparatus and a method of determining a surface characteristic or surface characteristics of a surface, for example using optical interferometric techniques.

A surface may have various surface characteristics. Surface form represents the lowest frequency surface variation and generally has a wavelength of the order of the scale of the surface whilst surface texture or surface roughness represents higher frequency surface variation. Many surfaces have both surface form and surface roughness or texture. For example, a cylindrical workpiece has a cylindrical surface form and may have a surface roughness or texture superimposed on that cylindrical form.

Various optical interferometric techniques have been used to determine surface characteristics such as surface texture or roughness. Examples are phase-stepping or phase-shifting interferometry (PSI) and coherence scanning interferometry (CSI).

Phase shifting interferometry (PSI) is discussed in, for example, Chapter 14 of the second edition of “Optical Shop Testing” edited by Daniel Malacara published in 1992 (ISBN 0-471-52232-5), the whole contents of which are hereby incorporated by reference. In PSI, a known time-varying phase shift is introduced between the reference wavefront and the sample wavefront in the interferometer so that a time varying signal is produced with the relative phase between the two wavefronts at a measurement location encoded in the signals for that measurement point. The phase shift may, for example, be introduced by translating a mirror or optical surface of the interferometer using a piezo-electric transducer. A two-dimensional image sensor is used to sense the resulting interference pattern or interferogram such that each sensing element or pixel of the image sensor senses the portion of the interferogram for a corresponding measurement point (surface region or surface pixel) of the sample surface. Various algorithms have been proposed to extract the actual phase at each point, each algorithm requiring a certain number of interferograms separated by a known phase step. An example discussed in the aforementioned Malacara reference is the four-step algorithm which requires four interferograms with a 90° optical phase shift introduced into the reference path of the interferometer between successive interferograms.

Coherence scanning interferometry (CSI) or broadband scanning interferometry (sometimes called “white light scanning interferometry”) is discussed in a paper entitled “Profilometry with a Coherence Scanning Microscope” by Byron S. Lee and Timothy C. Strand published in Applied Optics, volume 29, number 26, 10 Sep. 1990 at pages 3784 to 3788.

Coherence scanning interferometry uses a standard interferometer such as Michelson, Mirau or Linnik interferometer with a broadband spatially incoherent light source such as a quartz halogen lamp. Unlike narrowband or single wavelength interferometry, coherence scanning interferometry does not suffer from a wavelength limited unambiguous range but can provide practical measurement ranges exceeding hundreds of micrometers. In coherence scanning interferometry, one of the sample and reference mirror is moved relative to the other along a scan path to change the relative path length and a two-dimensional image sensor is again used to sense the resulting interference pattern or interferogram such that each sensing element or pixel of the image sensor senses the portion of the interferogram for a corresponding surface region or surface pixel of the sample surface. As the sample surface and reference mirror are moved relative to one another, the amount or intensity of light received by a sensing element will vary in accordance with the change in interference fringes, resulting in a coherence peak or extremum (maximum or minimum amplitude) occurring at a position along the scan path of zero path difference. Where different regions of the surface have different relative heights, then those different regions will have coherence peaks at different positions along with the scan path. Accordingly, the relative positions of the coherence peaks can be used to provide surface data, that is data representing the relative surface heights of different surface regions of the sample surface

Vibration-induced phase errors are one of the key limitations to the fundamental linearity of interferometers. A paper entitled ‘Vibration-resistant phase-shifting interferometry’ by Leslie Deck, published in Applied Optics, Vol. 35, No. 34, at pages 6655-6662, 1 Dec. 1996 proposes an approach to phase shifting interferometry in which a low speed high-density sensor captures high spatial resolution interferograms and a high-speed low-density image sensor captures high temporal resolution interferograms. The high temporal resolution data set is used to calculate the true phase increment between interferograms in the high spatial resolution data set and a generalised phase extraction algorithm is used to include these phase increments when the topographical phases in the high spatial resolution data set are calculated.

Another paper by Leslie Deck entitled ‘Suppressing phase errors from vibration in phase-shifting interferometry’, published in Applied Optics, Vol.48, no. 20, pages 3948-3960, 10 Jul. 2009 describes a Bessel function-based approach for suppressing phase errors in the field of phase shifting interferometry. However, vibration-induced phase errors remain an issue within the field of CSI.

Embodiments of the present invention aim to compensate for vibration-induced phase errors especially within the field of CSI.

An embodiment provides a metrological apparatus for determining a surface characteristic of a surface of a workpiece, the metrological apparatus comprising: a surface data determiner to determine from measurement data a measured surface roughness data set representing measured surface roughness and including any vibration induced measurement error; a harmonic model provider providing a harmonic model representing vibration-induced surface characteristics of the surface as a set of harmonic components selected based on a surface form of the surface of the workpiece; a surface roughness determiner to use the harmonic model and the measured surface roughness data to obtain a modified surface roughness data set in which vibration induced measurement error is suppressed.

The surface roughness determiner may be configured to determine a frequency domain window using the harmonic model, to apply the complement of the window to a frequency transform of the measured surface roughness data set to obtain windowed frequency transform data and to determine an inverse of the windowed frequency transform data to provide the modified surface roughness data set.

An embodiment provides a metrological apparatus for determining a surface characteristic of a surface of a workpiece, the metrological apparatus comprising: a surface data determiner to determine from measurement data a measured surface roughness data set representing measured surface roughness and including any vibration induced measurement error; a harmonic model provider providing a harmonic model representing vibration-induced surface characteristics of the surface as a set of harmonic components of a fundamental phase of a form of the surface of the workpiece; a vibration data determiner to determine vibration data using the measured surface roughness data set and the harmonic model; a surface roughness determiner to determine a modified surface roughness data set by subtracting the vibration data from the measured surface roughness data to obtain a modified surface roughness data set in which vibration induced measurement error is suppressed.

The harmonic model provider may be configured to provide a harmonic model representing vibration-induced surface characteristics of the surface as a set or series of weighted or modified harmonic components.

The harmonic model provider may be configured to model vibration-induced surface characteristics of the surface as a set of weighted harmonic components.

The harmonic model provider may be configured to model vibration-induced surface characteristics of the surface as a synthetic surface comprising set of weighted harmonic components in accordance with

[Z_{synth}]=Σ_{h=h min}^{h max}w(h)[cos(hΨ_{form})]

where w(h) is a weighting function

where Ψ_{form} is the phase of the form of the surface

where h ranges between hₘᵢₙ and hₘₐₓ where hₘᵢₙ is the lowest harmonic and hₘₐₓ is the highest harmonic.

Throughout this description, square parentheses indicate a 2D (x, y) array.

In an example, the harmonic model provider is configured to use a weighting function w(h) of the form

w(½)=0.25

w(h)=exp(A·exp(−Bh))

where A and B are dimensionless constants.

The vibration data provider may be configured to determine a frequency domain window using the harmonic model, to apply the window to a frequency transform of the measured surface roughness data set to obtain windowed frequency transform data and to determine an inverse of the windowed frequency transform data to provide the vibration data. In an example, the vibration data determiner is configured to limit the window in accordance with a threshold.

The harmonic model provider may be configured to model vibration-induced surface characteristics of the surface as a synthetic surface comprising harmonic components and the vibration data provider may be configured to apply a frequency transform to the synthetic surface to define a window, to apply the window to a frequency transform of the measured surface roughness data set to obtain windowed frequency transform data and then to determine an inverse of the windowed frequency transform data to provide the vibration data.

The harmonic model provider may be configured to model vibration-induced surface characteristics of the surface as a synthetic surface comprising a set of weighted harmonic components in accordance with:

[z_{synth}]=Σ_{h=h min}^{h max}w(h)[cos(hΨ_{form})]

where w(h) is a weighting function

where Ψ_{form} is the phase of the form of the surface

where h ranges between hₘᵢₙ and hₘₐₓ where hₘᵢₙ is the lowest harmonic (typically 0.5) and hₘₐₓ is the highest harmonic; and

the vibration data provider may be configured:

to determine a frequency transform of the harmonic model in accordance with

[Wₚ]=|ℑ_{x,y}([z_{synth}])|;

to define a window, W, as being zero, or unity where the modulus of the frequency transform components is above a threshold;

to apply the window to a frequency transform of the measured surface roughness data set; and

to determine a vibration data set in accordance with

[z_{vib}]=ℑ⁻¹_{fx,fy}([W],ℑ_{x,y}([z_{rough+vib}])).

The harmonic model provider may be configured to model vibration-induced surface characteristics of the surface as a sum of harmonics modified by a polynomial having unknown coefficients.

The harmonic model provider may be configured to model vibration-induced surface characteristics as a harmonic model comprising a sum of harmonics modified by a polynomial having unknown coefficients and the vibration data determiner may be configured to determine the vibration data by relating the harmonic model to the measured surface roughness data set and then solving for the coefficients of the polynomial. In an example, the vibration data determiner may be configured to use a least mean squares procedure to solve for the coefficients of the polynomial.

The harmonic model provider may be configured to provide a harmonic model representing vibration-induced surface characteristics of the surface as a set harmonic components modified by a polynomial modifier having coefficients and the vibration data determiner may be configured to determine the coefficients using a least mean squares approach in which the surface roughness is treated as a residual or error.

The harmonic model provider may be configured to model the vibration-induced surface characteristics as a harmonic model comprising a sum of harmonics modified by a polynomial in x and y having unknown coefficients a and b and the vibration data determiner may be configured to determine the vibration data by relating the harmonic model to the measured surface roughness data set and then solving for the coefficients a and b of the polynomial.

The harmonic model provider may be configured to model the vibration-induced surface characteristics as a harmonic model comprising a sum of harmonics modified by a polynomial in x and y having unknown coefficients a and b in accordance with:

[z_{vib}]=Σ_{h=h min}^{h max}([cos(hΨ_{form})]·Σⱼ₌₀ⁿΣₚ₌₀^{ĵ}aₕⱼₚ[x^{j-p}]·[y^{p}]+[sin(hΨ_{form})]·Σⱼ₌₀ⁿΣₚ₌₀^{ĵ}bₕⱼₚ[x^{j-p}]·[y^{p}])

where

ĵ=min(j,jₘₐₓ)

hₘᵢₙ is the lowest harmonic and hₘₐₓ is the highest harmonic,

Ψ_{form} is the phase corresponding to the form of the surface,

jₘₐₓ is the maximum power in y and n is the maximum power in x

and the vibration data determiner may be configured to determine the vibration data by relating the harmonic model to the measured surface roughness data set and then determining the coefficients of the polynomial using a least mean squares approach in which the surface roughness is treated as a residual or error.

The surface data determiner may be configured to receive an initial measurement data set comprising data representing the relative heights of different surface portions of a surface and the surface data determiner may comprise a surface form suppressor configured to carry out a form fitting process to determine from the received measurement data set a form of the surface to provide a form data set and to suppress the determined form in the measurement data set to provide the measured surface roughness data set as a form-suppressed data set. The harmonic model provider may configured to determine a fundamental phase of the form of the surface in accordance with

$$[ {Ψ}_{form} ] = \frac{4 π}{{λ}_{o}^{′}} [ {z}_{form} ]$$

where [z_{form}] is a data set representing the determined form and λ′₀ is the mean effective wavelength which is defined such that, if for a given (x,y) pixel location, the relative height of the local surface with respect to the reference surface changes by λ′₀/8, the interference phase changes by 90°.

The surface form suppressor may comprises a thresholder configured to determine a difference between the measurement data set and the form data set, to identify the location of any data for which the difference exceeds a threshold and to repeat the form fitting process excluding any locations for which the difference exceeds the threshold to refine the form-fitting. The refined form data set may then be removed from the measurement data set to provide the measured surface roughness data set as a form-suppressed data set.

The vibration data determiner may be configured to set the surface data values for any locations for which the difference exceeds the threshold to zero or a local mean. The surface roughness determiner may be configured to modify the modified surface roughness data for any locations for which the vibration data determiner had set the surface data value to zero or a local mean because the difference exceeded a threshold. For example, the modified surface roughness data for any such locations may be modified by the difference between the initial measurement data and the determined form data for that ‘bad’ data point.

The surface roughness determiner may be configured to use the harmonic model and the measured surface roughness data set to obtain the modified surface roughness data set.

An adder may be provided to add, for each surface portion, the modified surface roughness data to the form data to obtain a modified surface data set.

The surface data determiner may comprise an interferometric surface data determiner. In an example, the surface data determiner comprises a coherence scanning interferometer.

An embodiment provides a data processor for determining a surface characteristic of a surface of a workpiece, the data processor being configured:

to determine from measurement data a measured surface roughness data set representing measured surface roughness;

to provide a harmonic model representing vibration-induced surface characteristics of the surface as a set of harmonic components of a fundamental phase of a form of the surface of the workpiece;

to determine a modified surface roughness data set using the harmonic model and the measured surface roughness data to obtain a modified surface roughness data set in which vibration induced measurement error is suppressed.

The data processor may be configured to determine a frequency domain window using the harmonic model, to apply the complement of the window to a frequency transform of the measured surface roughness data set to obtain windowed frequency transform data and to determine an inverse of the windowed frequency transform data to provide the modified surface roughness data set.

An embodiment provides a data processor for determining a surface characteristic of a surface of a workpiece, the data processor being configured: to determine from measurement data a measured surface roughness data set representing measured surface roughness; to provide a harmonic model representing vibration-induced surface characteristics of the surface as a set of harmonic components of a fundamental phase of a form of the surface of the workpiece; to determine vibration data using the measured surface roughness data set and the harmonic model; to determine a modified surface roughness data set by subtracting the vibration data from the measured surface roughness data to obtain a modified surface roughness data set in which vibration induced measurement error is suppressed.

The harmonic model may represent vibration-induced surface characteristics of the surface as a set or series of weighted or modified harmonic components.

The harmonic model may model vibration-induced surface characteristics of the surface as a set of weighted harmonic components.

The harmonic model may model vibration-induced surface characteristics of the surface as a synthetic surface comprising set of weighted harmonic components in accordance with

[Z_{synth}]=Σ_{h=h min}^{h max}w(h)[cos(hΨ_{form})]

where w(h) is a weighting function,

where Σ_{form} is the phase of the form of the surface,

where h ranges between hₘᵢₙ and hₘₐₓ where hₘᵢₙ is the lowest harmonic and hₘₐₓ is the highest harmonic.

The weighting function w(h) may be of the form

w(½)=0.25

w(h)=exp(A·exp(Bh))

where A and B are constants.

The vibration data may be provided by determining a frequency domain window using the harmonic model, applying the window to a frequency transform of the measured surface roughness data set to obtain windowed frequency transform data and determining an inverse of the windowed frequency transform data to provide the vibration data. The window may be limited in accordance with a threshold.

The harmonic model may model vibration-induced surface characteristics of the surface as a synthetic surface comprising harmonic components and the data processor may be configured to apply a frequency transform to the synthetic surface to define a window, to apply the window to a frequency transform of the measured surface roughness data set to obtain windowed frequency transform data and then to determine an inverse of the windowed frequency transform data to provide the vibration data.

The harmonic model may model vibration-induced surface characteristics of the surface as a synthetic surface comprising a set of weighted harmonic components in accordance with

[z_{synth}]=Σ_{h=h min}^{h max}w(h)[cos(hΨ_{form})]

where w(h) is a weighting function,

where Σ_{form} is the phase of the form of the surface,

where h ranges between hₘᵢₙ and hₘₐₓ where hₘᵢₙ is the lowest harmonic and hₘₐₓ is the highest harmonic; and

the data processor may be configured

to determine a frequency transform of the harmonic model in accordance with:

[Wₚ]=|ℑ_{x,y}([z_{synth}])|;

to define a window, W, as being zero, or unity where the modulus of the frequency transform components is above a threshold;

to apply the window to a frequency transform of the measured surface roughness data set; and

to determine a vibration data set in accordance with

[z_{vib}]=ℑ⁻¹_{fx,fy}([W]·ℑ_{x,y}([z_{rough+vib}])).

where z[_{rough+vib}] is the measured surface roughness data set.

The harmonic model may model vibration-induced surface characteristics of the surface as a sum of harmonics modified by a polynomial having unknown coefficients.

The harmonic model may model vibration-induced surface characteristics as a sum of harmonics modified by a polynomial having unknown coefficients and the data processor may be configured to determine the vibration data by relating the harmonic model to the measured surface roughness data set, to solve for the coefficients of the polynomial and then to substitute these coefficients in the harmonic model to determine the vibration data.

The harmonic model may model vibration-induced surface characteristics of the surface as a set harmonic components modified by a polynomial modifier having coefficients and the data processor may be configured to determine the coefficients using a least mean squares approach in which the surface roughness is treated as a residual or error and then to substitute these coefficients in the harmonic model to determine the vibration data. In an example, the data processor is configured to use a least mean squares procedure to determine the coefficients of the polynomial.

The harmonic model may model the vibration-induced surface characteristics as a harmonic model comprising a sum of harmonics modified by a polynomial in x and y having unknown coefficients a and b in accordance with:

[z_{vib}]=Σ_{h=h min}^{h max}([cos(hΨ_{form})]·Σⱼ₌₀ⁿΣₚ₌₀^{j}aₕⱼₚ[x^{j-p}]·[y^{p}]+[sin(hΨ_{form})]·Σⱼ₌₀ⁿΣₚ₌₀^{j}bₕⱼₚ[x^{j-p}]·[y^{p}])

and the data processor may be configured to determine the vibration data by relating the harmonic model to the measured surface roughness data set, determining the coefficients of the polynomial using a least mean squares approach in which the surface roughness is treated as a residual or error and then substituting the determined coefficients in the above equation.

The data processor may receive a measurement data set comprising data representing the relative heights of different surface portions of a surface, and may be configured to determine from the received measurement data set a form of the surface and to suppress the determined form from the measurement data set to provide the measured surface roughness data set.

The harmonic model may determine a fundamental phase of the form of the surface in accordance with

$$[ {Ψ}_{form} ] = \frac{4 π}{{λ}_{o}^{′}} [ {z}_{form} ]$$

where [z_{form}] is a data set representing the determined form and λ′₀ is the mean effective wavelength which is defined such that, if for a given (x,y) pixel location, the relative height of the local surface with respect to the reference surface changes by λ′₀/8, the interference phase changes by 90°.

The data processor may be configured to add, for each surface portion, the surface roughness data to the form data to obtain a modified surface data set.

The data processor may be configured to determine a difference between the measurement data set and the form data set to identify the location of any data for which the difference exceeds a threshold and to repeat the form fitting process excluding any locations for which the difference exceeds the threshold to refine the form-fitting. The refined form data set may then be removed from the measurement data set to provide the measured surface roughness data set.

The data processor may be configured to use the harmonic model and the measured surface roughness data set to obtain the modified surface roughness data set.

When determining the vibration data, the data processor may be configured to set the surface data values for any locations for which the difference exceeds a threshold to zero or a local mean. The data processor may be configured to modify the modified surface roughness data for any locations for which, because the difference exceeded the threshold, the surface data value had been set zero or a local mean. For example, the modified surface roughness data for any such locations may be modified by the difference between the initial measurement data and the determined form data for that ‘bad’ data point.

The data processor may comprise computing apparatus programmed by program instructions.

An embodiment provides a method of determining a surface characteristic of a surface of a workpiece, the method comprising:

determining from measurement data a measured surface roughness data set representing measured surface roughness and including any vibration induced measurement error;

providing a harmonic model representing vibration-induced surface characteristics of the surface as a set of harmonic components of a fundamental phase of a form of the surface of the workpiece;

using the measured surface roughness data set and the harmonic model to obtain a modified surface roughness data set in which vibration induced measurement error is suppressed; and

outputting the modified surface roughness data set.

Using the measured surface roughness data set and the harmonic model to obtain a modified surface roughness data set may comprise determining a frequency domain window using the harmonic model, applying the complement of the window to a frequency transform of the measured surface roughness data set to obtain windowed frequency transform data and determining an inverse of the windowed frequency transform data to provide the modified surface roughness data set.

An embodiment provides a method of determining a surface characteristic of a surface of a workpiece, the method comprising: determining from measurement data a measured surface roughness data set representing measured surface roughness and including any vibration induced measurement error; providing a harmonic model representing vibration-induced surface characteristics of the surface as a set of harmonic components of a fundamental phase of a form of the surface of the workpiece; determining vibration data using the measured surface roughness data set and the harmonic model; determining a modified surface roughness data set by subtracting the vibration data from the measured surface roughness data to obtain a modified surface roughness data set in which vibration induced measurement error is suppressed; and outputting the modified surface roughness data set.

The harmonic model may represent vibration-induced surface characteristics of the surface as a set or series of weighted or modified harmonic components.

The harmonic model may model vibration-induced surface characteristics of the surface as a set of weighted harmonic components.

The harmonic model may model vibration-induced surface characteristics of the surface as a synthetic surface comprising set of weighted harmonic components in accordance with

[z_{synth}]=Σ_{h=h min}^{h max}w(h)[cos(hΨ_{form})]

where w(h) is a weighting function,

where Ψ_{form} is the phase of the form of the surface,

where h ranges between hₘᵢₙ and hₘₐₓ where hₘᵢₙ is the lowest harmonic and hₘₐₓ is the highest harmonic.

The harmonic model may use a weighting function w(h) of the form

w(½)=0.25

w(h)=exp(A·exp(−Bh))

where A and B are dimensionless constants.

Determining the vibration data may comprise determining a frequency domain window using the harmonic model, applying the window to a frequency transform of the measured surface roughness data set to obtain windowed frequency transform data and determining an inverse of the windowed frequency transform data to provide the vibration data. The window may be limited in accordance with a threshold. The harmonic model may model vibration-induced surface characteristics of the surface as a synthetic surface comprising harmonic components and the method may comprise applying a frequency transform to the synthetic surface to define a window, applying the window to a frequency transform of the measured surface roughness data set to obtain windowed frequency transform data and then determining an inverse of the windowed frequency transform data to provide the vibration data.

The harmonic model may model vibration-induced surface characteristics of the surface as a synthetic surface comprising a set of weighted harmonic components in accordance with:

[z_{synth}]=Σ_{h=h min}^{h max}w(h)[cos(hΨ_{form})]

where w(h) is a weighting function,

where Ψ_{form} is the phase of the form of the surface,

where h ranges between hₘᵢₙ and hₘₐₓ where hₘᵢₙ is the lowest harmonic and hₘₐₓ is the highest harmonic; and

the method may further comprise:

determining a frequency transform of the harmonic model in accordance with

[Wₚ]=|ℑ_{x,y}([z_{synth}])|;

defining a window, W, as being zero, or unity where the modulus of the frequency transform components is above a threshold;

applying the window to a frequency transform of the measured surface roughness data set; and

determining a vibration data set in accordance with

[z_{vib}]=ℑ⁻¹_{fx,fy}([W]·ℑ_{x,y}([z_{rough+vib}])).

where z[_{rough+vib}] is the measured surface roughness data set.

The harmonic model may model vibration-induced surface characteristics of the surface as a sum of harmonics modified by a polynomial having unknown coefficients.

The harmonic model may model vibration-induced surface characteristics as a harmonic model comprising a sum of harmonics modified by a polynomial having unknown coefficients and the method may further comprise relating the harmonic model to the measured surface roughness data set and then solving for the coefficients of the polynomial to determine the vibration data. A least mean squares procedure may be used to solve for the coefficients of the polynomial.

The harmonic model may represent vibration-induced surface characteristics of the surface as a set harmonic components modified by a polynomial modifier having coefficients and the method may comprise determining the coefficients using a least mean squares approach in which the surface roughness is treated as a residual or error.

The harmonic model may model the vibration-induced surface characteristics as a harmonic model comprising a sum of harmonics modified by a polynomial in x and y having unknown coefficients a and b and the method may comprise determining the vibration data by relating the harmonic model to the measured surface roughness data set and then solving for the coefficients a and b of the polynomial.

The harmonic model may model the vibration-induced surface characteristics as a harmonic model comprising a sum of harmonics modified by a polynomial in x and y having unknown coefficients a and b in accordance with:

[z_{vib}]=Σ_{h=h min}^{h max}([cos(hΨ_{form})]·Σⱼ₌₀ⁿΣₚ₌₀^{ĵ}aₕⱼₚ[x^{j-p}]·[y^{p}]+[sin(hΨ_{form})]·Σⱼ₌₀ⁿΣₚ₌₀^{ĵ}bₕⱼₚ[x^{j-p}]·[y^{p}])

where

ĵ=min(j,jₘₐₓ)

hₘᵢₙ is the lowest harmonic and hₘₐₓ is the highest harmonic

and jₘₐₓ is the maximum power in y and n is the maximum power in x

and the method may comprise determining the vibration data by relating the harmonic model to the measured surface roughness data set and then determining the coefficients of the polynomial using a least mean squares approach in which the surface roughness is treated as a residual or error.

The method may further comprise receiving a measurement data set comprising data representing the relative heights of different surface portions of a surface and determining the surface data by carrying out a form fitting process to determine from the received measurement data set a form of the surface to provide a form data set.

The harmonic model may determine a fundamental phase of the form of the surface in accordance with

$$[ {Ψ}_{form} ] = \frac{4 π}{{λ}_{o}^{′}} [ {z}_{form} ]$$

where [z_{form}] is a data set representing the determined form and λ′₀ is the mean effective wavelength which is defined such that, if for a given (x,y) pixel location, the relative height of the local surface with respect to the reference surface changes by λ′₀/8, the interference phase changes by 90°.

The method may further comprise determining a difference between the Measurement data set and the form data set, identifying the location of any data where the difference exceeds a threshold and repeating the form fitting process excluding any locations for which the difference exceeds the threshold to refine the form-fitting. The refined form may then be removed from the measurement data set to provide the measured surface roughness data set.

The surface data values for any locations for which the difference exceeds the threshold may be set to zero or to a local mean during determination of the vibration data. The data values in the modified surface roughness data may be adjusted for any locations for which, because the difference exceeded the threshold, the surface data value was previously set to zero or a local mean. For example, the modified surface roughness data for any such locations may be modified by the difference between the initial measurement data and the determined form data for that ‘bad’ data point.

The modified surface roughness data may be determined using the harmonic model and the measured surface roughness data set.

The surface roughness data may be added to the form data to obtain a modified surface data set.

The method may be carried out by computing apparatus programmed by program instructions.

An embodiment provides a computer program product comprising program instructions that when executed by computing apparatus cause the computing apparatus to carry the method. The computer program product may comprise at least one of a storage medium and a signal.

An embodiment provides a non-transitory computer program product, such as a non-transitory storage medium, storing program instructions that when executed by computing apparatus cause the computing apparatus to carry the method.

Embodiments of the present invention will now be described, by way of example, with reference to the accompanying drawings, in which:

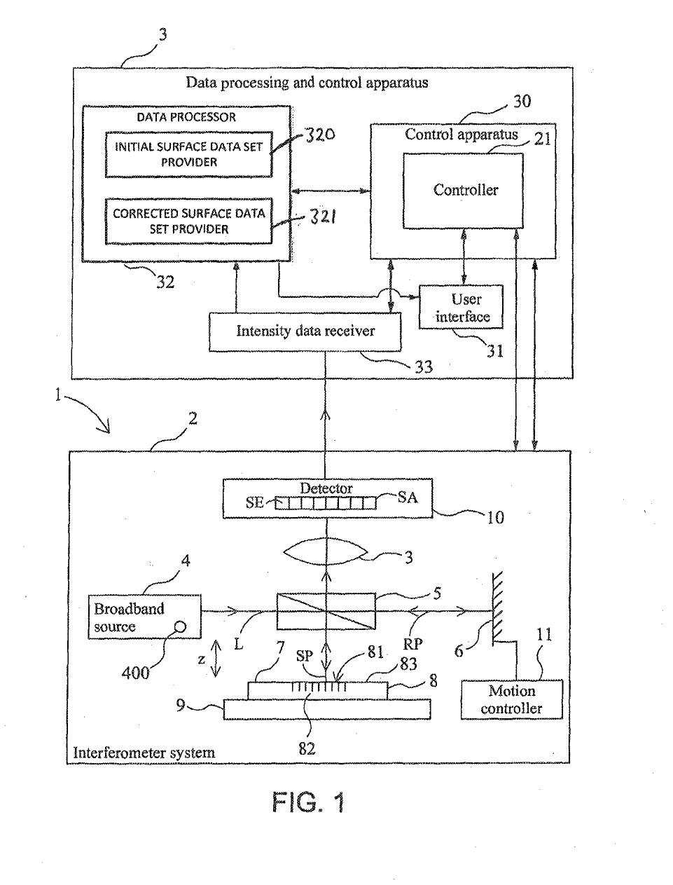

FIG. 1 shows a schematic block diagram of metrological apparatus for determining a surface characteristic;

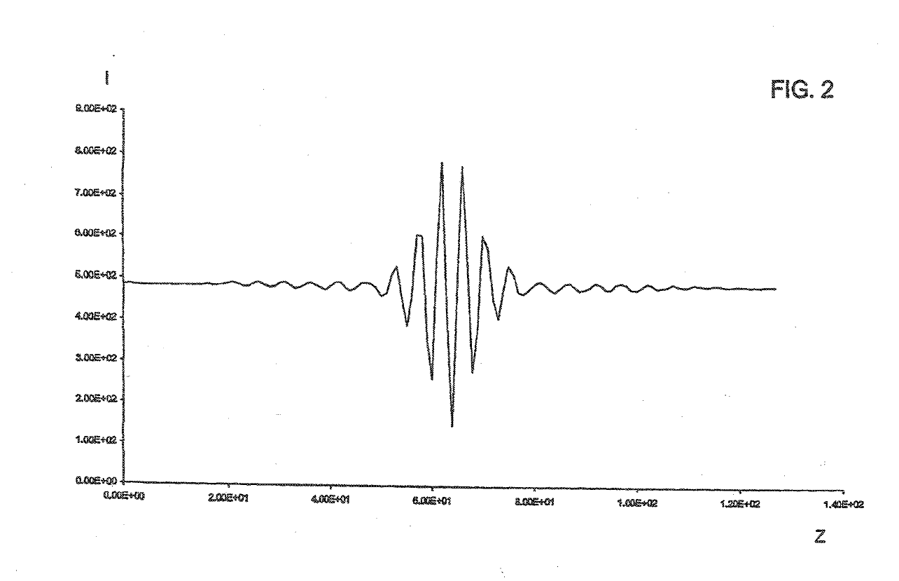

FIG. 2 shows a graph of intensity I against scan path position z to illustrate a typical example of the interference fringes for a sample surface region around a coherence peak or interference region;

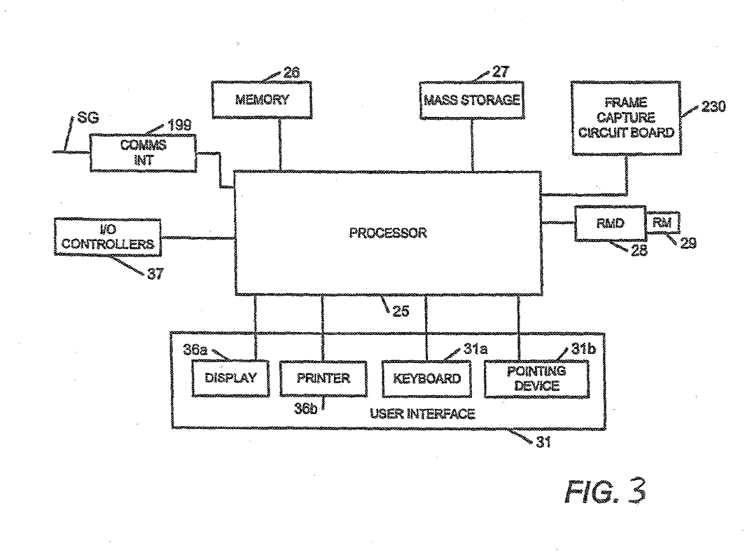

FIG. 3 shows a functional block diagram of computing apparatus that may be configured to provide the data processing and control apparatus shown in FIG. 1;

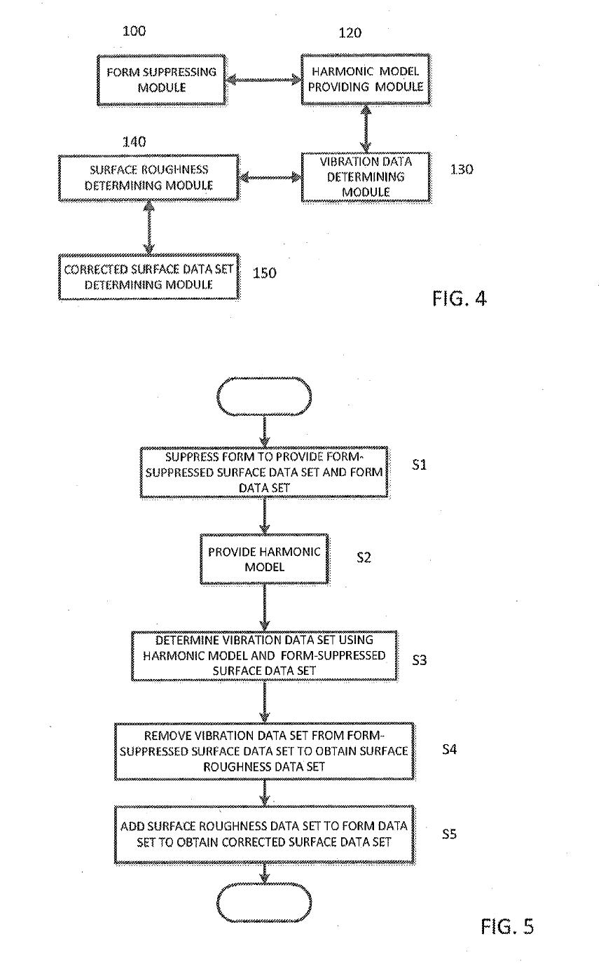

FIG. 4 shows a block diagram providing an overview of the functionality provided by a corrected surface data set provider of the data processing and control apparatus shown in FIG. 1;

FIG. 5 shows a flow chart illustrating processes carried out by the corrected surface data set provider shown in FIG. 4;

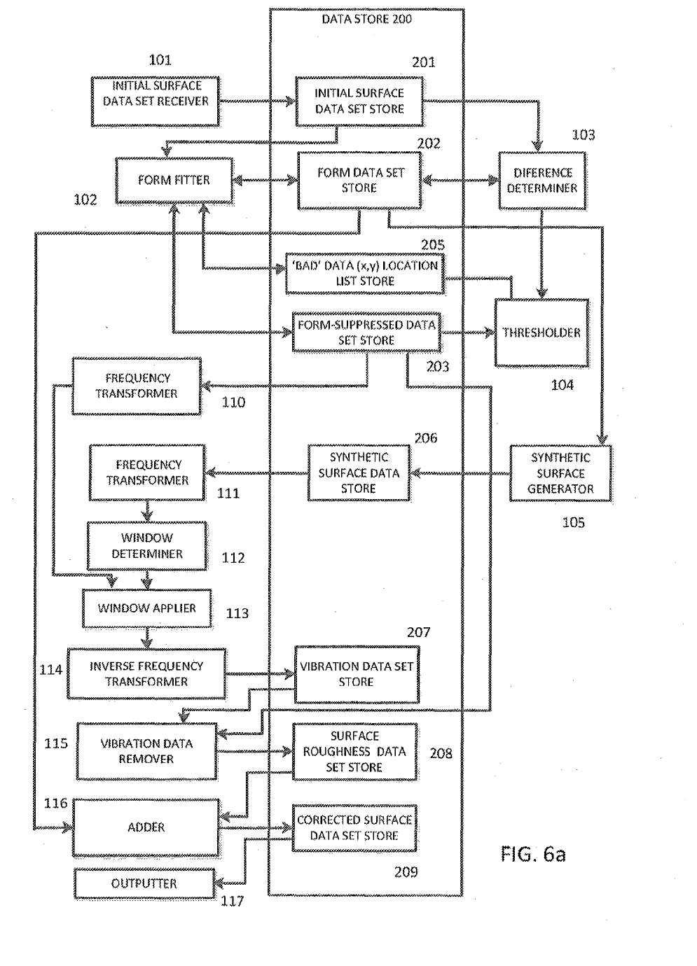

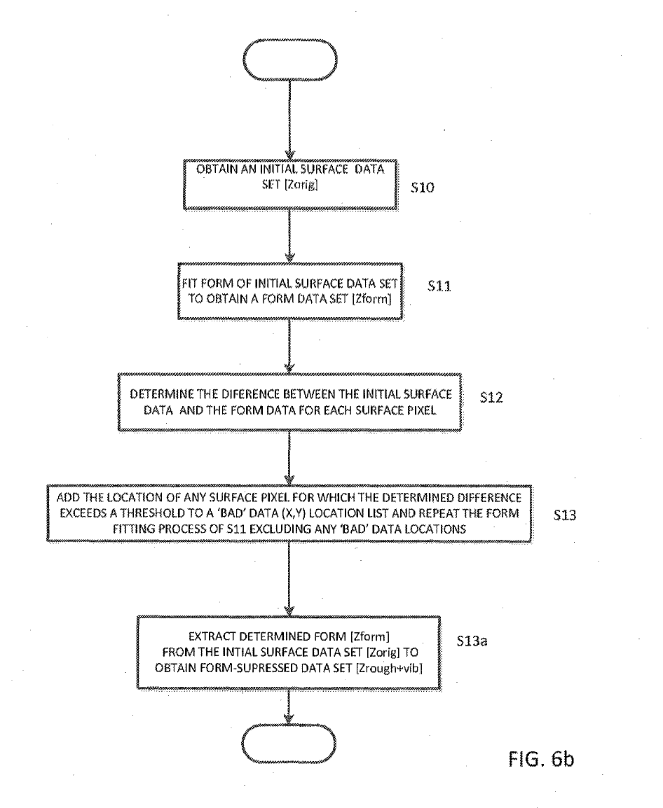

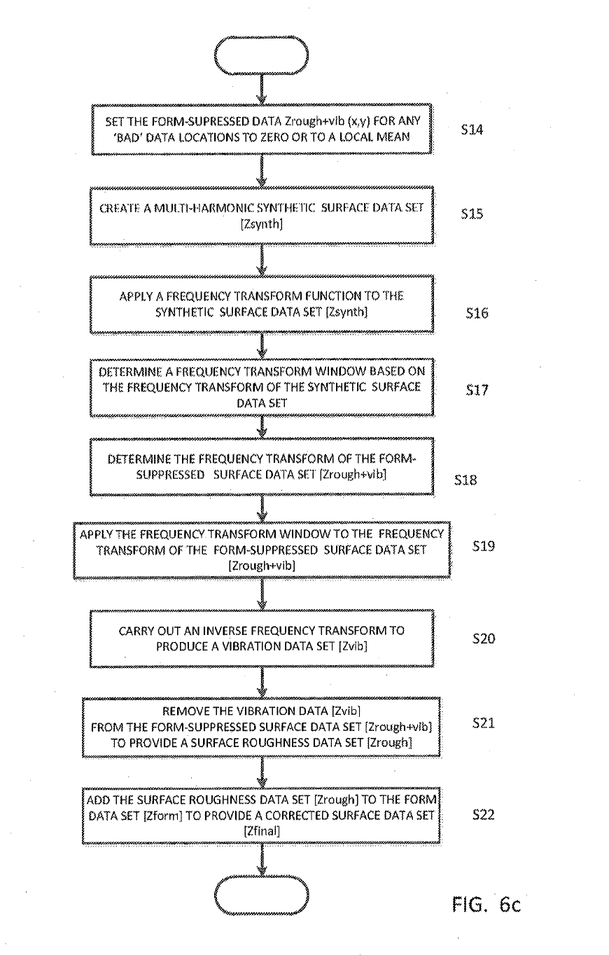

FIG. 6a shows a block diagram illustrating one embodiment of the corrected surface data set provider;

FIGS. 6b and 6c show a flow chart illustrating processes carried out by the corrected surface data set provider shown in FIG. 6a;

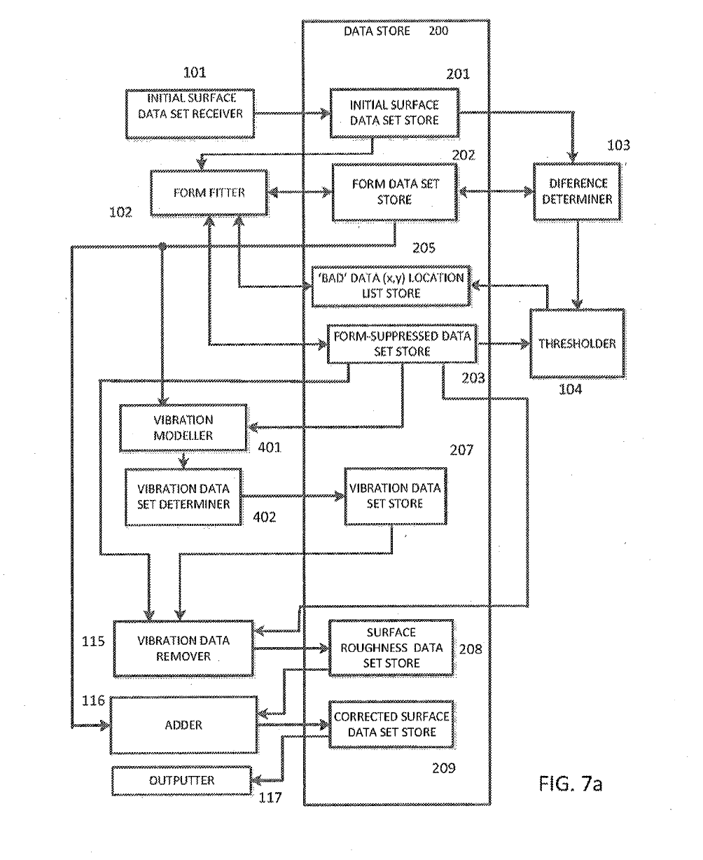

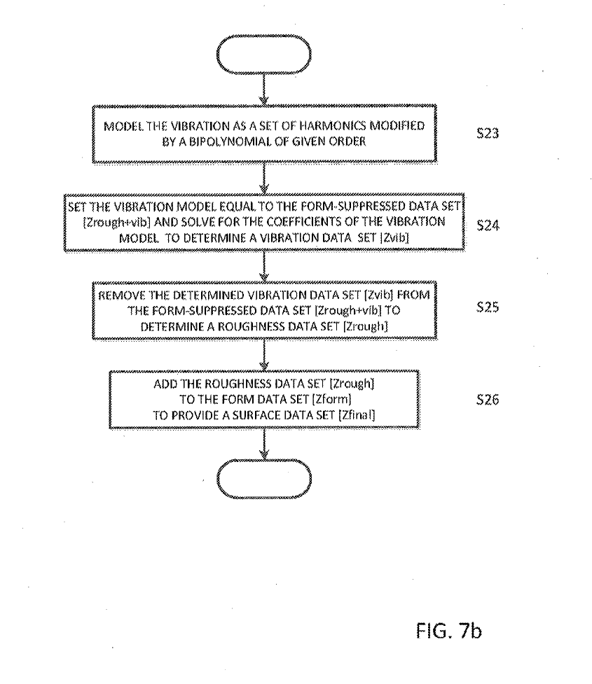

FIG. 7a shows a block diagram illustrating another embodiment of the corrected surface data set provider of the data processing and control apparatus shown in FIG. 1;

FIG. 7b shows a flow chart illustrating processes carried out by the corrected surface data set provider shown in FIG. 7a;

FIGS. 8 to 16 show results obtained using a process or method as illustrated in FIGS. 6b and 6c where the original surface is a hyperboloid surface with

FIG. 8 showing a gray scale version of a false colour image of an initial hyperboloid surface data set,

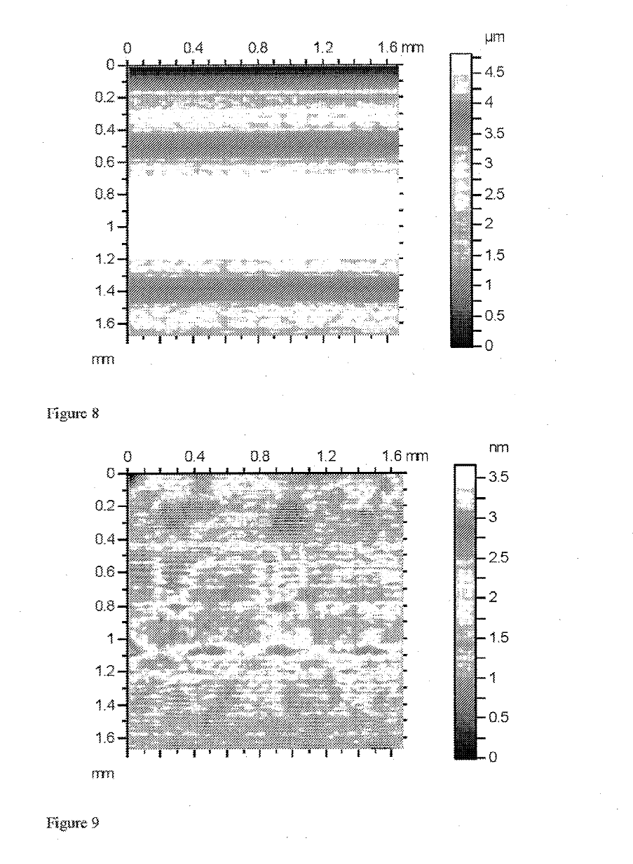

FIG. 9 showing a gray scale version of a false colour image of the initial hyperboloid surface data set with form suppressed,

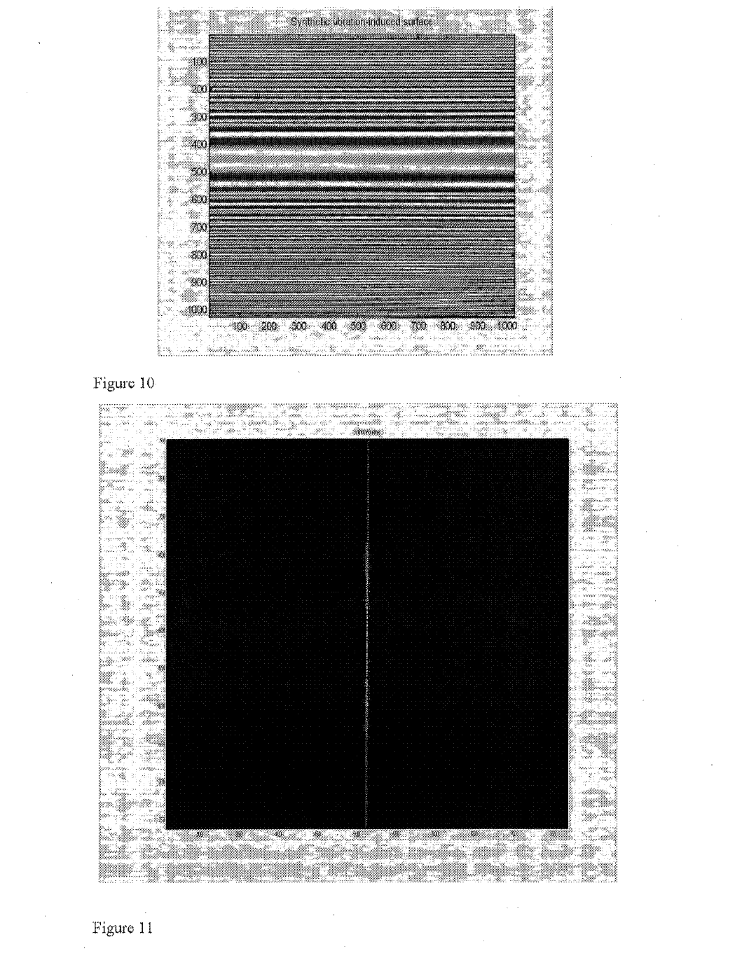

FIG. 10 showing a gray scale version of a false colour image of a synthetic multi-harmonic surface corresponding to a hyperboloid,

FIG. 11 showing an enlarged view of an initial window (pre-window) corresponding to a hyperboloid,

FIG. 12 showing a final window corresponding to the hyperboloid,

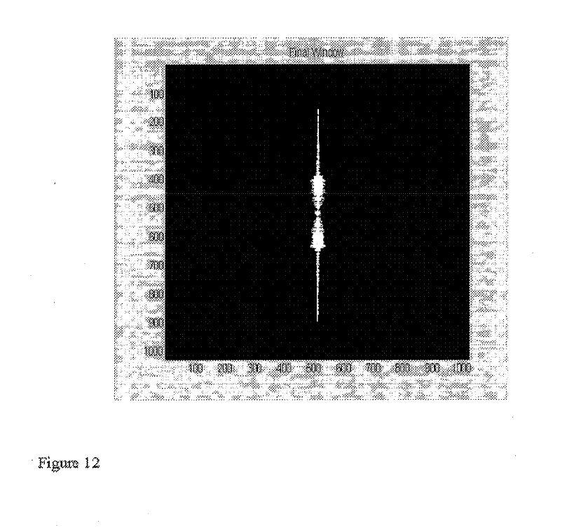

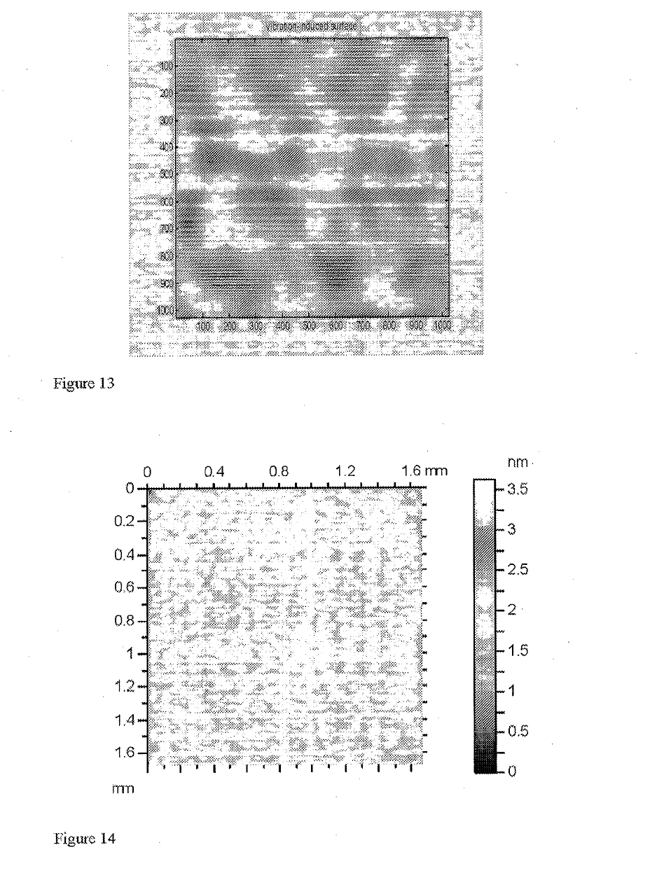

FIG. 13 showing a gray scale version of a false colour image of a vibration-induced surface data set obtained for the hyperboloid surface,

FIG. 14 showing a gray scale version of a false colour image of a corrected form-suppressed surface data set obtained for the hyperboloid surface,

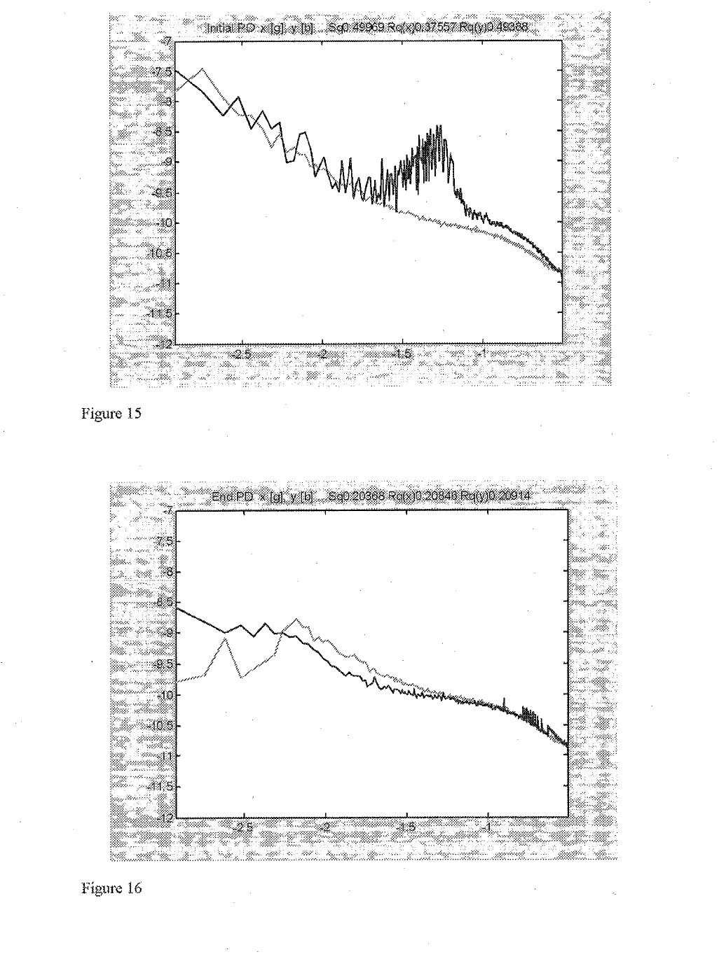

FIG. 15 showing initial x and y axis power spectra for the hyperboloid surface, and

FIG. 16 showing final x and y axis power spectra for the hyperboloid surface;

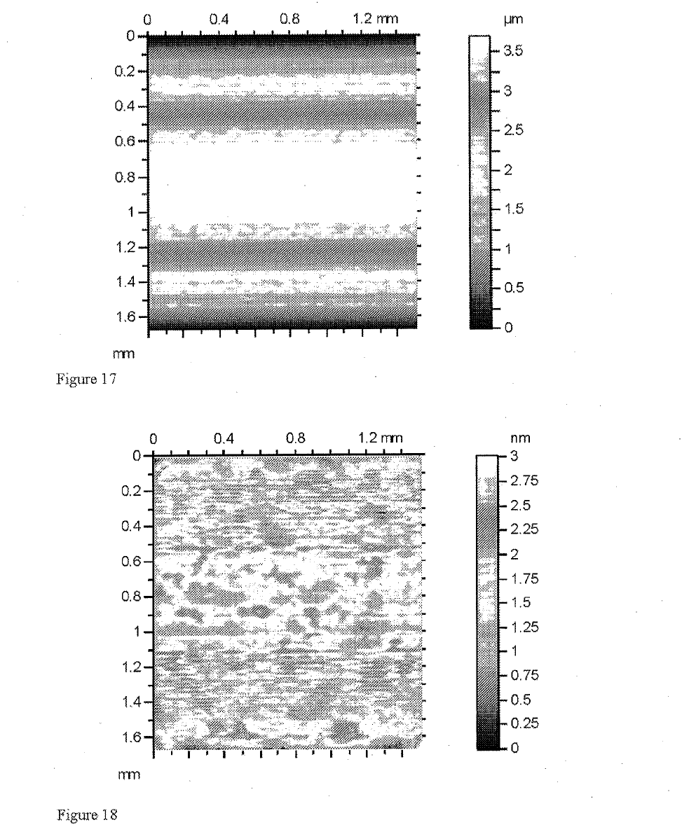

FIGS. 17 to 28 show results obtained using a process or method as illustrated in FIGS. 6b and 6c where the original surface is a paraboloid surface with

FIG. 17 showing a gray scale version of a false colour image of an initial paraboloid surface data set,

FIG. 18 showing a gray scale version of a false colour image of the initial paraboloid surface data set shown in FIG. 17 with form suppressed,

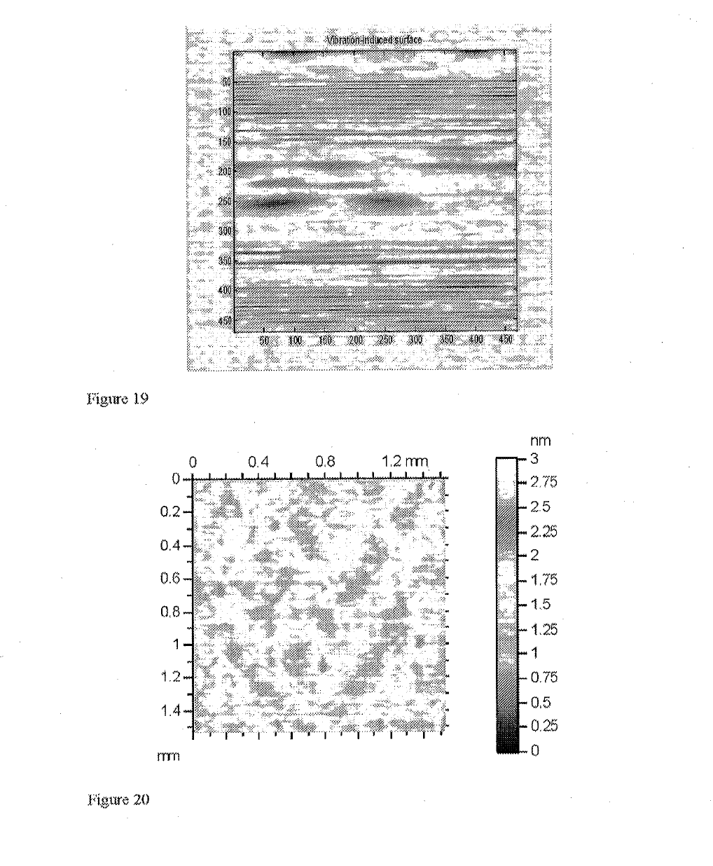

FIG. 19 showing a gray scale version of a false colour image of the vibration-induced surface data set obtained for the paraboloid surface,

FIG. 20 showing a gray scale version of a false colour image of the corrected form-suppressed surface data set for the paraboloid surface,

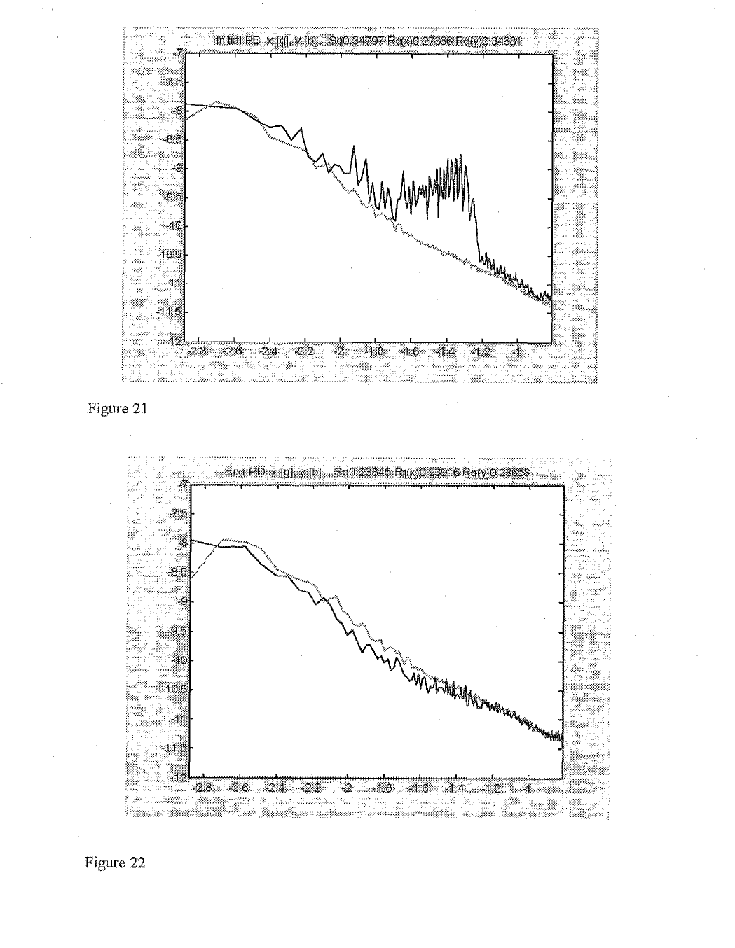

FIG. 21 showing initial x and y axis power spectra for the paraboloid surface, and

FIG. 22 showing final x and y axis power spectra for the paraboloid surface;

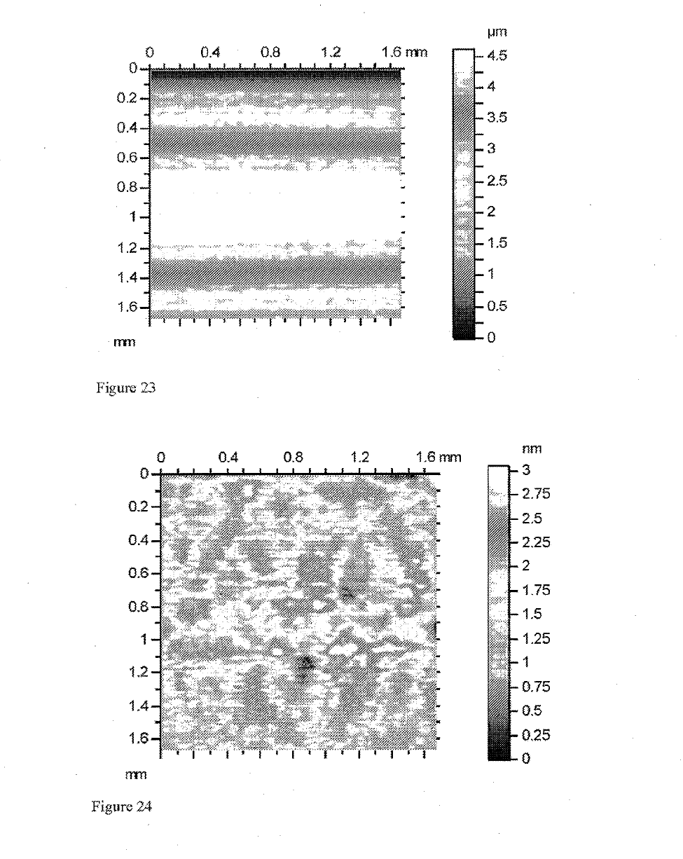

FIGS. 23 to 28 show results obtained using a process or method as illustrated in FIGS. 6b and 7b where the original surface is a paraboloid surface with

FIG. 23 showing a gray scale version of a false colour image of an initial paraboloid surface data set,

FIG. 24 showing a gray scale image of a false colour image of the initial paraboloid surface data set shown in FIG. 23 with form suppressed;

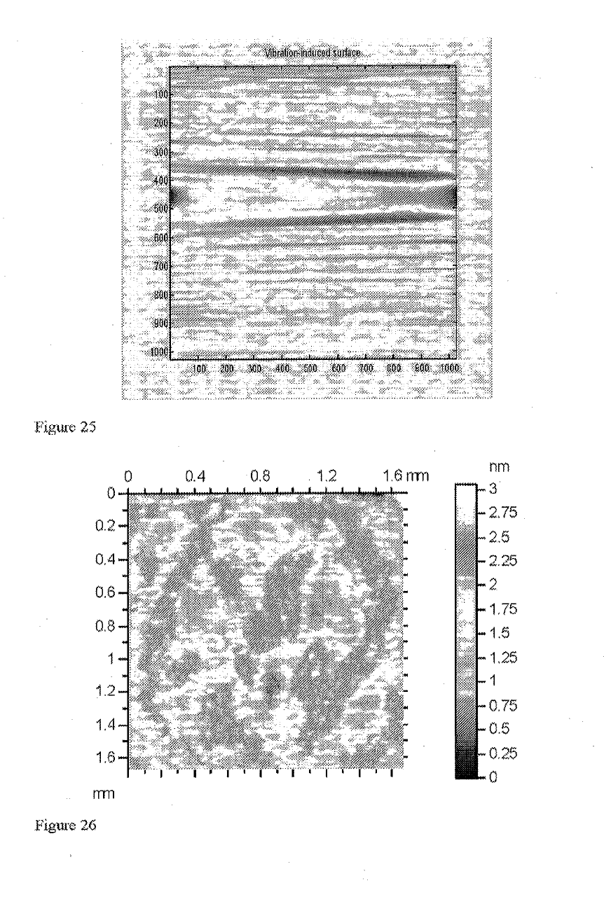

FIG. 25 showing a gray scale image of a false colour image of the vibration-induced surface data set obtained for a paraboloid surface,

FIG. 26 showing a gray scale image of a false colour image of the corrected form-suppressed surface data set,

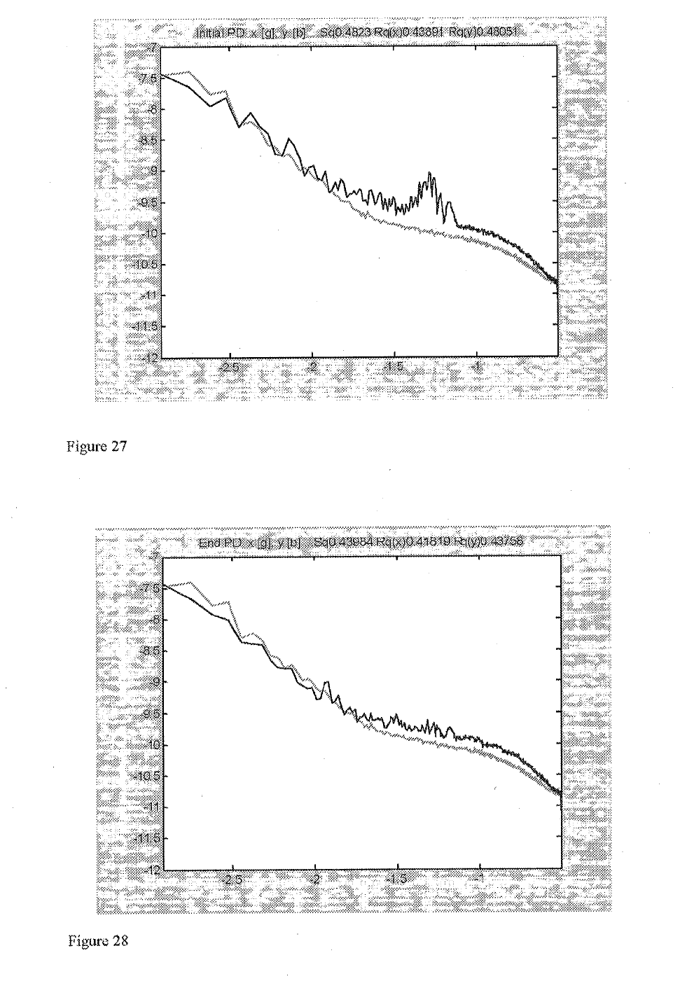

FIG. 27 showing initial x and y axis power spectra for the paraboloid surface;

FIG. 28 showing final x and y axis power spectra for the paraboloid surface;

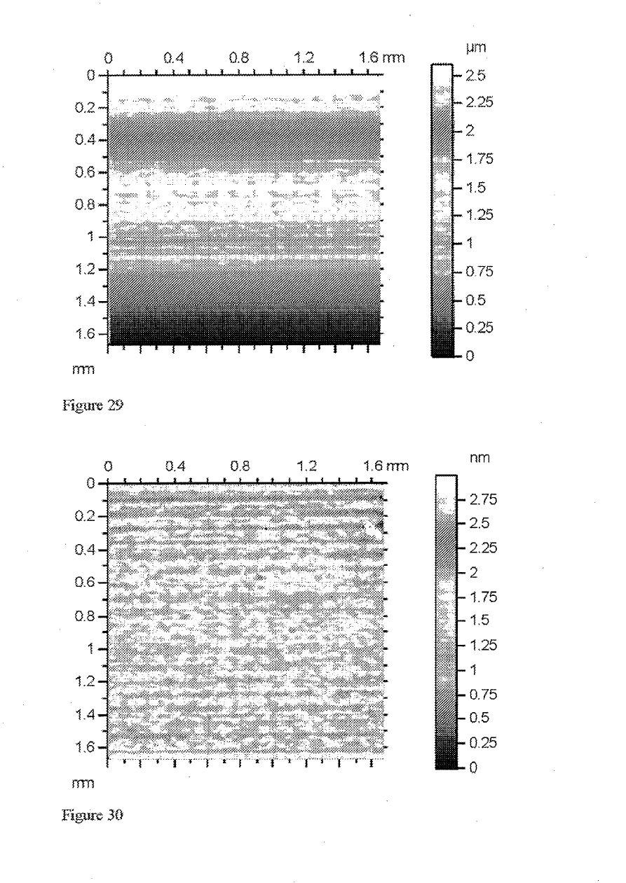

FIGS. 29 to 34 show results obtained using a process or method as illustrated in FIGS. 6b and 7b where the original surface is a tilted flat surface with

FIG. 29 showing a gray scale image of a false colour image of the initial surface data,

FIG. 30 showing a gray scale image of a false colour image of the initial tilted flat surface data with form suppressed,

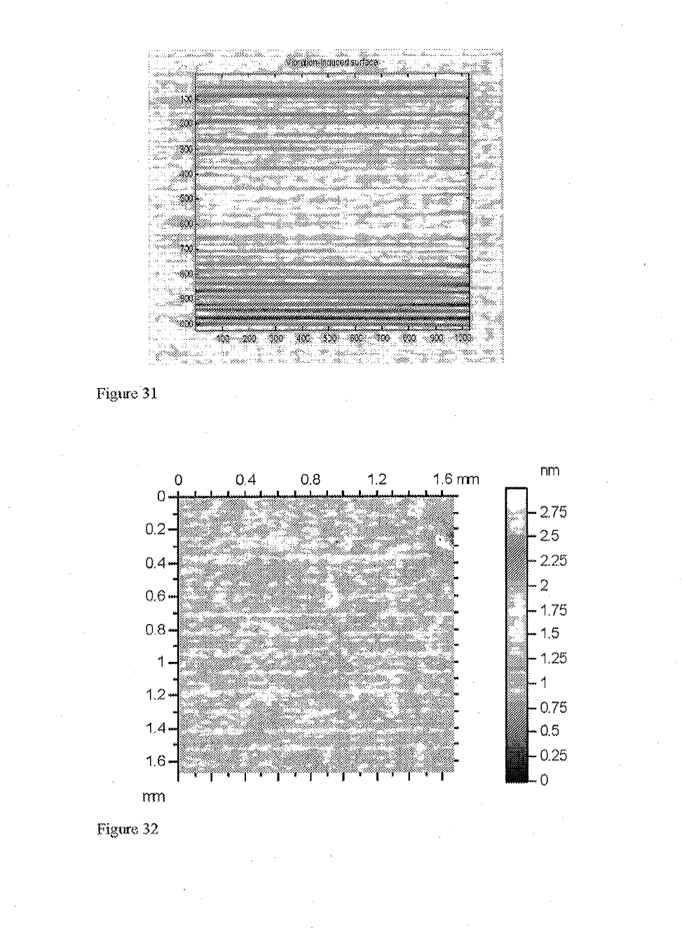

FIG. 31 showing a gray scale image of a false colour image of the vibration-induced surface data,

FIG. 32 showing a gray scale image of a false colour image of the corrected form-suppressed surface data set,

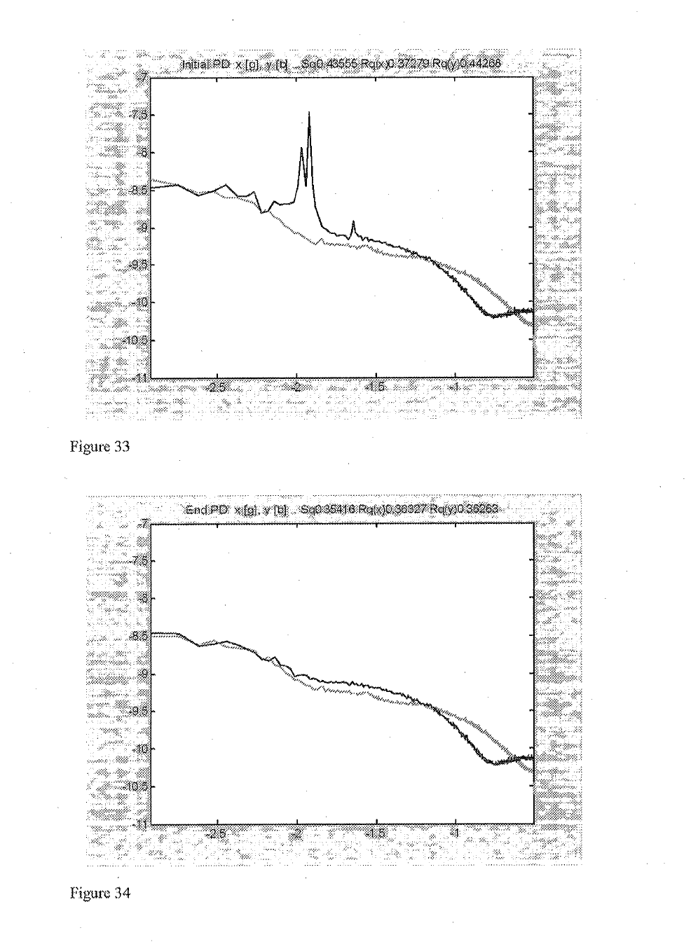

FIG. 33 showing initial x and y axis power spectra, and

FIG. 34 showing final x and y axis power spectra.

Referring now to the drawings, FIG. 1 shows a simplified schematic block diagram of metrological apparatus for determining a surface characteristic of a sample surface, such as surface roughness (texture) alone or with surface form.

The apparatus 1 has a coherence scanning interferometer system 2 and a data processing and control apparatus 3.

The coherence scanning interferometer system 2 is based on a conventional interferometer and, as an example, may have a Mirau, Michelson or Linnik configuration.

A broadband light source 4 (for example using a quartz halogen lamp 400) provides broadband light L which is split by a beam splitter 5 into a first light beam which is directed along a reference path RP towards a reference mirror 6 and a second light beam which is directed along a sample path SP towards a surface 7 of a sample 8 mounted on a sample support stage 9. Light reflected from the reference mirror 6 returns along the reference path RP to the beam splitter 5 where it interferes with light reflected from the sample surface 7 back along the sample path SP. A focusing element 3 is provided to focus an image of the region of interference onto a detector 10. The detector 10 may have a 2-D (two-dimensional) array SA of image sensing elements SE, one array of which is shown very schematically in FIG. 1. Each individual sensing element SE detects the portion of the interference pattern falling within the acceptance cone of that element and resulting from a corresponding surface region or surface pixel of the area of the sample surface 7 so that, effectively, the imaged area of the surface can be considered as a 2-D array of surface regions or surface pixels.

A motion controller 11 is provided to effect relative movement between the sample 8 and the reference mirror 6. As shown in FIG. 1, the motion controller 11 is arranged to move the reference mirror 6 and objective lens (not shown) combination along the reference path RP. This is equivalent to moving the sample surface 7 along the scan path in the z direction shown in FIG. 1 and as another possibility, rather than moving the reference mirror 6 and objective lens combination, the sample surface 7 may be moved along the scan path (that is the direction z in FIG. 1) to effect the relative movement between the sample 8 and the reference mirror 6.

The intensity of the illumination sensed by one sensing element SE varies as the scan path length difference changes with movement of the reference mirror 6 (or the sample 8), resulting in a series of fringes which have a coherence peak at the position along the scan path corresponding to a zero path length difference. FIG. 2 shows a graph of light intensity I against position z that illustrates the manner in which the intensity of the light sensed by a sensing element SE changes as the relative positions of the reference mirror 6 and sample surface 7 change.

Examples of interferometer systems that may be used in the apparatus shown in FIG. 1 are disclosed in, for example, U.S. Pat. No. 7,385,707, U.S. Pat. No. 7,970,579, U.S. Pat. No. 7,440,116, U.S. Pat. No. 7,948,634, U.S. Pat. No. 7,518,733, U.S. Pat. No. 7,755,768, U.S. Pat. No. 7,697,726, the whole contents of each of which are hereby incorporated by reference. Other forms of interferometer system that are suitable for use in CSI may be used.

At least the controller 21 and data processor 32 of the data processing and control apparatus 3 may be implemented by programming computing apparatus, for example a personal computer. FIG. 3 shows a simplified block diagram of such computing apparatus. As shown, the computing apparatus has a processor 25 associated with memory 26 (ROM and/or RAM), a mass storage device 27 such as a hard disk drive, a removable medium drive (RMD) 28 for receiving a removable medium (RM) 29 such as a floppy disk, CD-ROM, DVD or the like, and input and output (I/O) controllers 37 for interfacing with components of the interferometer system 2 to be controlled by the control apparatus 30. The computing apparatus may have one or more input ports such as USB ports for enabling data communication with external devices. The user interface 31 may consist of, for example, a keyboard 31a, a pointing device 31b, a display such as a CRT or LCD display 36a, and a printer 36b. The computing apparatus may include a communications interface (COMMS INT) 199 such as a MODEM or network card to enable the computing apparatus to communicate with other computing apparatus over a network such as the local area network (LAM), wide area network (LAN), an intranet or the Internet. In this example, the intensity data receiver 33 is provided as a dedicated frame capture circuit board 230 installed within the computing apparatus.

As shown in FIG. 1, the data processor 32 has an initial surface data set provider 320 and a corrected surface data set provider 321. The initial surface data set provider 320 may be any suitable form of surface data set provider that processes the intensity data (interferograms) received by the intensity data receiver 33 to determine, for each surface pixel of the area of the surface under the examination, the position along the z scan path at which the coherence peak occurs and so to determine, for each surface pixel, surface height data representing the relative height of that surface pixel on the surface area. As an example, the initial surface data set provider 320 may process the interferograms using any of the methods described in U.S. Pat. No. 7,385,707 or U.S. Pat. No. 7,948,634, the whole contents of which are hereby incorporated by reference. The phase that corresponds to the local surface height, z, that is the phase surface corresponding to the initial surface data set, [zᵢₙᵢₜᵢₐₗ] (elsewhere herein called [z_{orig}]), is given by equation 1a) below:

$$[ Ψ ] = \frac{4 π}{{λ}_{o}^{′}} [ {z}_{initial} ] \qquad 1 a )$$

Throughout this description, square parentheses indicate a 2D (x, y) array.

Here A:, is the mean effective wavelength which is defined such that, if for a given (x,y) pixel location, the relative height of the local surface with respect to the reference surface changes by λ′₀/8, the interference phase changes by 90°.

The corrected surface data provider 321 acts to correct the initial surface data set by suppressing vibration-induced phase errors. Examples of the corrected surface data provider 321 will now be described.

FIG. 4 shows a block diagram providing an overview of the functionality provided by the corrected surface data set provider 321 whilst FIG. 5 shows a flow chart illustrating an overview of processes carried out by the corrected surface data set provider 321.

As illustrated in FIG. 4, the corrected surface data set provider 321 has a form suppressing module 100, a harmonic model providing module 120, a vibration data determining module 130, a surface roughness determining module 140 and a corrected surface data set determining module 150.

The form suppressing module 100 is configured or arranged to produce from the initial surface data set [zᵢₙᵢₜᵢₐₗ]: 1) a form-suppressed data set, [z_{rough+vib}], which consists of form-suppressed data for each surface pixel, the form-suppressed data comprising surface roughness and vibration and instrument noise components of the initial surface data set; 2) a form data set, [z_{form}], which excludes surface roughness and vibration and instrument noise components of the initial surface data set and so consists of form data for each surface pixel of the initial surface data set; and 3) a listing of the (x,y) locations of the surface pixels for which the initial surface data is considered ‘bad’ data, typically because of surface debris. In this example, a surface pixel location is considered a ‘bad’ data (x,y) location if the magnitude of the difference between the original initial surface data set and the fitted form data set ([zᵢₙᵢₜᵢₐₗ] and [z_{form}]) exceeds a threshold consisting of the product of the standard deviation of that surface difference and a factor (such as 5). The extensive listing of ‘good’ data (x,y) locations is evidently the complement of the ‘bad’ data (x,y) listing. Any suitable form-fitting process may be used such as, for example, a least-squares form-fitting process.

The form suppressing module 100 may configured or arranged to refine the determination of the form data set, [z_{form}], by repeating the fitting process excluding any ‘bad’ data (x,y) locations. This process generates a refined form data set [z_{form}]. [. This iterative compensation for ‘bad’ data locations is used to enable a better form fit. Once this procedure is completed, then the determined form data set [z_{form}] is extracted from the initial or measured surface data set [zᵢₙᵢₜᵢₐₗ] to provide a form-suppressed data set [z_{rough+vib}] and a list of any ‘bad’ data locations. The harmonic model providing module 120 is configured or arranged to provide a harmonic model modelling vibration effects as a set of weighted or modified harmonic components for which the fundamental is the phase corresponding to the fitted form, [z_{form}]:

$$[ {Ψ}_{form} ] = \frac{4 π}{{λ}_{o}^{′}} [ {z}_{form} ] \qquad 1 b )$$

The harmonic model providing module 120 may generate the model or may store a previously generated model to which the determined phase is applied.

The vibration data determining module 130 is configured or arranged to use the form-suppressed data set [z_{rough+vib}] and the harmonic model to determine a modelled vibration data value for each surface pixel, thereby providing a modelled vibration data set [z_{vib}]. The form-suppressed data set [z_{rough+vib}] may first be modified to adjust outlying values (that is the ‘bad’ data (x,y) locations which may have resulted from surface debris), for example to set them equal to zero or to replace them with values determined from the data values for a local subset of the ‘good’ data (x,y) locations of z_{rough+vib}(x,y). This process is justified because the average of this data set is zero or near zero.

Identification of any ‘bad’ data (x,y) locations and adjustment of their values is desirable because the surface height modulation induced by microscopic debris and surface contaminant-induced ‘fringe order’ errors is typically some three orders of magnitude greater than the vibration-induced topographical modulation and so may swamp the vibration-induced topographical modulation.

The surface roughness determining module 140 is configured or arranged to remove the modelled vibration data [z_{vib}] for each surface pixel from the corresponding form-suppressed data [z_{rough+vib}] to produce a surface roughness data set [z_{rough}]. As a good working compromise to maintain the fidelity of the original measurement, for any ‘bad’ data (x,y) locations, the local roughness value z_{rough} (x,y) in the surface roughness data set [z_{rough}] may be modified by the addition of the difference zᵢₙᵢₜᵢₐₗ(x,y)−z_{form}(x,y), thus completing the surface roughness data set [z_{rough}].

The corrected surface data set determining module 150 is configured or arranged to add the thus-determined surface roughness data for each surface pixel to the corresponding form data to obtain a corrected surface data set in which vibration-induced phase errors have been suppressed.

FIG. 5 shows processes carried out by the corrected surface data set provider 321.

At S1, a surface is fitted to the initial surface data set to determine a form data value for each surface pixel. The surface may be fitted by, for example, fitting a polynomial using a least-squares form-fitting process. A thresholding process may be used to determine and store a list of any (x,y) locations for which the surface pixel data value is above a threshold (outlying “bad” data (x,y locations or points). If there are any ‘bad’ data locations, the form-fitting may be repeated, after having excluded the initial ‘bad data’ (x,y) locations, to yield a revised form data set [z_{form}] and a revised set or list of ‘bad’ data (x,y) locations. The form data values are stored as a form data set [z_{form}] and then, for each surface pixel, the difference between its form data value and its initial surface data value is determined and these difference data values are stored as a form-suppressed data set [z_{rough+vib}].

At S2 a harmonic model is provided modelling vibration effects as a set of weighted or modified harmonic components of the fundamental phase corresponding to the form determined by the form-suppressing module. The harmonic model may be generated at this stage or may be pre-stored.

At S3 the form-suppressed data set and the harmonic model are used to determine a modelled vibration data value for each surface pixel, thereby providing a modelled vibration data set, [z_{vib}]. The form-suppressed data set [z_{rough+vib}] may first be modified to adjust outlying values ('bad' data (x,y) locations which may have resulted from surface debris), for example to set them equal to zero or to replace them with values determined from the data values for a local subset of the ‘good’ data (x,y) locations of z_{rough+vib}(x,y) (a local mean).

At S4, the modelled vibration data [z_{vib}] for each surface pixel is subtracted from the corresponding form-suppressed data [z_{rough+vib}] to produce a surface roughness data value for each surface pixel and the resulting data is stored as a surface roughness data set [z_{rough}]. For any ‘bad’ data (x,y) locations whose surface data values have previously been set to zero or a local mean, the local roughness value z_{rough}(x,y), having now been corrected for vibration-induced error, may be modified by the addition of the difference zᵢₙᵢₜᵢₐₗ(_{x,y)-z}_{form}(x,y) thus completing the data set [z_{rough}]. This is a good working compromise regarding maintaining the fidelity of the original measurement,

At S5, the determined surface roughness data [z_{rough}] for each surface pixel is added to the corresponding form [z_{form}] to obtain a corrected surface data set [z_{final}] in which vibration-induced phase errors have been suppressed.

FIG. 6a shows a block diagram illustrating one embodiment of the corrected surface data set provider whilst FIGS. 6b and 6c show flow charts illustrating processes carried out by the corrected surface data set provider shown in FIG. 6a.

Referring now to FIGS. 6a, 6b and 6c, in this example a predictive frequency transform filtering process, usually a Fourier filtering process, is used to suppress vibration-induced phase errors.

The corrected surface data provider 321 has or has access to a data store 200 providing data storage facilities. The data store 200 may or may not be shared by other parts of the data processor 32.

In this example the data store 200 provides an initial surface data set store 201, a form data set store 202, a form-suppressed data set store 203, a listing of ‘bad’ data (x,y) locations store 205, a synthetic surface data store 206, a vibration data set store 207, a surface roughness data set store 208 and a corrected surface data set store 209.

The form suppressing module 100 has an initial surface data set receiver 101 to receive an initial surface data set [zᵢₙᵢₜᵢₐₗ] from the initial surface data set provider 320, a form fitter 102 to carry out a fitting process, for example using a least squares approach, to fit a surface, usually defined by polynomial, to the initial surface data set and to store the resulting form data set [z_{form}] in the form data set store 202 and a difference determiner 103 to determine, for each surface pixel, the difference between its form data value and its initial surface data value and to store the difference data as a form-suppressed data set [z_{rough+vib}] in the form-suppressed data set store 203.

In this example, the form suppressing module 100 also has a thresholder 104 to identify any surface pixels ((x,y) locations) for which the difference data exceeds a standard deviation-based threshold (originally based upon the behaviour of a number of similarly produced surfaces). If there are any such ‘bad’ data locations, the thresholder 104 is arranged to store these locations as a ‘bad’ data (x,y) locations list in the ‘bad’ data (x,y) locations store 205 and the form-fitter is arranged to repeat the form-fitting, after having excluded the initial ‘bad data’ (x,y) locations, to yield a revised form data set [z_{form}] that is stored in the form data set store 202 to replace the previous form data set. Repeating the thresholding process generates a revised set of ‘bad’ data (x,y) locations that is stored in the ‘bad’ data location store 205 to replace the previous ‘bad’ data (x,y) locations list

This iterative compensation for ‘bad’ data locations is used to enable a better form fit which may improve definition of the harmonic model. Once this procedure is completed then the determined form is extracted from the initial or measured surface data set to provide the final form-suppressed data set z[_{rough+vib}] which is stored in the form-suppressed data set store 203.

The harmonic model providing module in this example is provided by a synthetic surface generator 105 and the synthetic surface data store 206. The synthetic surface generator 105 is configured or arranged to generate a synthetic multi-harmonic surface comprising a set of weighted or modified harmonic components of the fundamental phase of the form determined by the form-suppressing module, as will be explained below. The synthetic surface data store 206 stores data representing the synthetic multi-harmonic surface generated by the synthetic surface generator 105.

The vibration data determining module 130 is configured to set the surface data values of any ‘bad’ data (x,y) locations to zero or a local mean and to store the thus-modified form-suppressed data set, z[_{rough+vib}] in the form-suppressed surface data set store 203.

The vibration data determining module 130 has a first frequency transformer 110 to provide a frequency transform of the form-suppressed surface data set [z_{rough+vib}] and a second frequency transformer 111 to provide a frequency transform of the synthetic multi-harmonic surface [z_{synth}]. The first and second frequency transformers 110 and 111 may or may not be provided by the same functionality.

A window determiner 112 is provided to use the frequency transform of the synthetic multi-harmonic surface data [z_{synth}] to determine a 2D frequency transform pre-window, [Wₚ], and then to define a window, [W], from the pre-window. A window applier 113 is configured or arranged to apply the window to the frequency transform of the form-suppressed surface data set [z_{rough+vib}], to produce a windowed data set and an inverse frequency transformer 114 is configured or arranged then to determine an inverse frequency transform of the windowed data set to provide a modelled vibration data set [z_{vib}] which is stored in the vibration data set store 207.

The surface roughness determining module 140 is provided by a vibration data remover 115 which is configured or arranged to subtract, for each surface pixel, the vibration data, [z_{vib}], stored in the vibration data set store 207 from the corresponding form-suppressed data [z_{rough+vib}] stored by the form-suppressed data set store 203 to define the corrected surface roughness, [z_{rough}]. If the number of ‘bad data’ locations in the ‘bad’ data location store 205 is not zero, the vibration data suppresser 115 is arranged to modify the local roughness value z_{rough}(x,y) for each ‘bad’ data location by the addition of the difference zᵢₙᵢₜᵢₐₗ(x,y)−z_{form}(x,y) for that ‘bad’ data point, thus completing the data set [z_{rough}]. which is stored in the roughness data set store 208.

The corrected surface data set determining module 150 is provided by an adder 116 configured or arranged to add the determined surface roughness data [z_{rough}] for each surface pixel to the corresponding form data [z_{form}] stored in the form data set store 202 to obtain a corrected surface data set [z_{final}] in which vibration-induced phase errors have been suppressed. The corrected surface data set [z_{final}] is stored in the corrected surface data set store 209 and may be output by an outputter 117 to a resource such as any one or more of a display, a printer or a communications device for communication to another device such as another computing apparatus.

An example of a predictive Fourier filtering process to suppress CSI vibration-induced phase errors will now be described with the aid of FIGS. 6b and 6c. This process or method may, but need not necessarily, use the corrected surface data provider described above with reference to FIG. 6a.

Referring first to FIG. 6b, at S10 an initial or original surface data set [zᵢₙᵢₜᵢₐₗ] representing the surface heights zᵢⱼ of the surface pixels is obtained. This may be provided by the initial surface data set provider 320 shown in FIG. 1. As set out above, the initial surface data set provider 320 may be any suitable form of surface data set provider that processes the intensity data (interferograms) received by the intensity data receiver 33 to determine, for each surface pixel of the area of the surface under the examination, the position along the z scan path at which the coherence peak occurs and so, for each surface pixel, surface height data representing the relative height of that surface pixel on the surface area. As an example, the initial surface data set provider 320 may process the interferograms using any one of the methods described in U.S. Pat. No. 7,385,707, the whole contents have previously been hereby incorporated by reference.

Now referring to FIGS. 6b and 6c, at S10 in FIG. 6b an initial z surface data set, [z_{orig}], is obtained from the initial surface data set provider 320. At S11, the corresponding form data set, [z_{form}], is determined by first fitting a surface to the initial surface data set [z_{orig}] to obtain an initial form data set. Then at S12 the difference between the initial surface data and the form data is determined for each surface pixel and at S13 a determination is made as to whether the modulus of [z_{orig}]−[z_{form}] exceeds a standard deviation-based threshold which may be experimentally determined as explained elsewhere herein. At S13, the fitting procedure may be repeated excluding the bad data points to generate a revised form data set [z_{form}] and a revised list of ‘bad’ data (x,y) locations. This procedure provides both the fitted form, [z_{form}] and a list of ‘bad’ data' (x,y) locations. The surface fitted to the data may be any appropriate order 2D polynomial, where a 2D or bivariate polynomial is a polynomial in x and y. In this example, a 7^{th} order polynomial in x and y is used.

This iterative procedure is used to enable a better form fit which may improve definition of the harmonic model. Once this procedure is completed then at S13a the determined form is extracted from the initial or measured surface data set to provide the final form-suppressed data set [z_{rough+vib}] which is stored in the form-suppressed data set store 203. The form-suppressed data set, [z_{rough+vib}], represents the contribution to the surface of roughness, vibration and any instrument noise.

We therefore have as set out in equation 2) below:

$$\begin{matrix}[ {z}_{form} ] \& [ {Ψ}_{form} ] = \frac{4 π}{{λ}_{o}^{′}} [ {z}_{form} ] \& [ {z}_{rough + vib} ] \\ = ( [ {z}_{orig} ] - [ {z}_{form} ] ) \& {( x , y )}_{bad}\end{matrix} \qquad 2 )$$

Where

[z_{orig}] is the initial surface data set;

[z_{form}] is the form data set

[z_{rough+vib}] is the form-suppressed data set

[Ψ_{form}] is the phase corresponding to the surface z_{form}

square parentheses indicate a 2D (x, y) array, and

(x,y)_{bad} is the listing of pixel locations whose initial surface data values are interpreted as being ‘bad’ data and as resulting from surface debris.

[z_{rough+vib}] is essentially a perturbation of [z_{form}] and accordingly at S14 (FIG. 6b), for any ‘bad’ data point locations identified above, it is a reasonable approximation temporarily to set z_{rough+vib}(x,y) to zero (or a local mean) at these locations.

Through Fourier-transforming surfaces it has been shown experimentally that they exhibit harmonics, h, of diminishing amplitude beyond the 2^{nd} harmonic. The harmonics are typically the fundamental together with even harmonics, but occasionally the fundamental together with the sub-harmonic (h=½) and both even and odd harmonics. On this basis, at S15 in FIG. 6c, a synthetic multi-harmonic surface [z_{synth}] is created on the assumed harmonics of h=½, 1 and even and odd integers. The synthetic multi-harmonic surface comprises a Fourier series of the harmonics as set out in equation 3) below:

[z_{synth}]=Σ_{h=h min}^{h max}w(h)[cos(hΨ_{form})] 3)

where Ψ_{form} is the phase of the form of the surface,

where h ranges between hₘᵢₙ and hₘₐₓ where hₘᵢₙ is the lowest harmonic (typically 0.5) and hₘₐₓ is the highest harmonic (typically the minimum of a user-specified value (typically 6) and double the number of fringes),

and the weighting function w(h) mimics the typical actual harmonic amplitude distribution and in this example is of the form:

w(½)=0.25

w(h)=exp(A·exp(−Bh)) 4)

Empirically, it has been shown that reasonable values for the dimensionless constants A and B are A=8.14 and B=0.1275.

For reasons which will be explained below, the values of the dimensionless constants and the function used to give relative weightings to the harmonics of the fundamental form-phase are not critical and other functions may be used

This synthetic surface is therefore based upon harmonics of the actual phase surface [Ψ_{form}] which provides the fundamental on which the harmonics are based; not known are the amplitudes and phases of these harmonic components together with the frequency broadening that results from their variation over the field of view. A Fourier approach is used to determine the actual surface, [z_{vib}].

Thus at S16 in FIG. 6c, a 2D Fourier transform is applied to the synthetic surface data set, [z_{synth}], to yield a ‘pre-window’, [Wₚ], defined, as set out in equation 5) below, as the modulus of the 2D Fourier transform of the synthetic surface:

[Wₚ]=|ℑ_{x,y}([z_{synth}])| 5)

An equivalent 2D Fourier ‘window’, [W], is then defined at S17 as unity if [Wₚ] exceeds a user-specified threshold (typically between 0.005 and 0.1, the smaller the value the greater the bandwidth broadening interpreted as corresponding to the vibration-induced surface) and zero elsewhere. This ‘window’, [W], is therefore based upon the harmonic/form-based amplitude pattern in the Fourier domain, with a ‘line-width’ dependent on the user-specified threshold. The 2D Fourier transform of the form-suppressed surface data set is determined at S18.

The process at S18 is independent of the processes at S15 to S17 and so the order shown in FIG. 6c need not necessarily be followed. All that matters is that, at the end of S18, the window [W] has been defined and the Fourier transform of the form-suppressed data set [z_{rough+vib}] has been obtained.

At S19, the window [W] is applied to the frequency transform of the form-suppressed surface data set [z_{rough+vib}] and at S20 an inverse 2D Fourier transform is carried out as shown in equation 6) below to determine the vibration-induced surface, [z_{vib}].

[z_{vib}]=ℑ⁻¹_{fx,fy}([W]·ℑ_{x,y}([z_{rough+vib}])). 6)

This window defining procedure relies on the effect of the vibration being localised in the frequency domain and in essence relies upon the form of the surface under test having a major axis or direction to provide a directional structure in the harmonic model. Thus, this procedure relies upon the fact that certain surface forms such as tilted flats, cylinders and surfaces that within the field of view behave substantially as tilted flats or cylinders (the latter including hyperboloids and paraboloids) have a directionality (defined by the axis of the cylinder or the tilt of the flat) so that the harmonic transforms are essentially localised, allowing ‘minimum footprint’ filtering.

Transforming the synthetic surface as discussed above exposes the spatial distribution of its Fourier components; the subsequent windowing extracts the actual vibration-component Fourier terms from the transform of the original surface. The function w(h) used to give relative weighting to the harmonics of the fundamental phase that defines the synthetic vibration-induced surface is not critical because, if the synthetic surface bandwidth (as defined by the weighting function w(h)) is greater than the vibration component within the actual surface, then the only effect is that the extracted vibration-induced surface [z_{vib}] will additionally contain a marginal amount of ‘white’ noise that has been transferred through the window. Apart from the convolution with the transform of the bounded form of the surface, the transform of the vibration-induced surface is localised whereas the transform of the surface roughness is not.

At S21 a surface roughness data set [z_{rough}] is obtained by subtracting the vibration data value obtained for each surface pixel from the corresponding value in the form-suppressed surface data set as shown in equation 7) below:

[z_{rough}]=[z_{rough+vib}]−[^{z}_{vib}] 7)

If the listing of ‘bad’ data (x,y) locations whose initial surface data values are interpreted as resulting from surface debris, is not zero, then for these surface pixel locations z_{rough}(x,y) is modified by adding the difference z_{orig}(x,y)−z_{form}(x,y):

z_{rough}(x,y) [symbol] z_{rough}(x,y)+(z_{orig}(x,y)−z_{form}(x, y)) 8)

to provide the final surface roughness data set [Z_{rough}].

This compensates for the fact that, to avoid distortion to [z_{vib}] arising from threshold-exceeding data, z_{rough+vib}(x,y) was originally set to zero (or the local mean) at any ‘bad data’ (x,y) locations.

Then at S22, for each surface pixel, the corresponding roughness data value is added to the value in the form data set to obtain a corrected surface data set representing the corrected surface as shown in equation 9) below:

[z_{final}]=[z_{form}]+[z_{rough}] 9)

FIGS. 8 to 22 illustrate the carrying out of the process described above by reference to FIGS. 6b and 6c on an initial surface data set representing the results of a measurement by a coherence scanning interferometer (CSI) of a surface area of a two surfaces, one being a hyperboloid and the other a paraboloid, both measured with a x10 objective.

FIGS. 8, 9, 10, 13, 14, 17, 18, 19 and 20 are gray scale versions of original false colour images in which relative surface heights were represented by different colours. The scale to the right in FIGS. 8, 9, 14, 17, 18 and 20 indicates the relationship between the colour in the false colour image and the surface height in micrometres (μm).

FIGS. 8 to 16 show the results produced for an initial surface data set where the initial surface was a hyperboloid. FIG. 8 shows the gray scale version of a false colour image of the initial surface data set [z_{orig}] whilst FIG. 9 shows the gray scale version of a false colour image of the initial hyperboloid surface data set shown in FIG. 8 with form suppressed, that is FIG. 9 shows the form-suppressed data set [z_{rough+vib}] obtained at S11. FIG. 10 shows a gray scale image of a false colour image of a synthetic multi-harmonic surface [z_{synth}] created at S15 in FIG. 6c. FIG. 11 shows an enlarged view of the pre-window [Wₚ] and FIG. 12 shows the final window [W] determined at S17 In FIG. 6c for the hyperboloid. FIG. 13 shows the gray scale version of a false colour image of the vibration-induced surface, that is the vibration data set, [z_{vib}], obtained for the hyperboloid surface at S20 whilst FIG. 14 shows a gray scale image of a false colour image of the corrected form-suppressed surface data set [z_{trough}] obtained for the hyperboloid surface at S21 in FIG. 6c. FIG. 15 shows initial x and y axis power spectra whilst FIG. 16 shows final x and y axis power spectra for the hyperboloid surface. FIGS. 15 and 16 have logarithmic y axis scales. The reduction in the vibration-induced surface power spectra is evident.

FIGS. 17 to 22 show the results produced for an initial surface data set where the initial surface was a paraboloid. FIG. 17 shows the gray scale version of a false colour image of the initial surface height data set [z_{orig}] whilst FIG. 18 shows the gray scale version of a false colour image of the initial paraboloid surface data set shown in FIG. 17 with form suppressed, that is FIG. 18 shows the form-suppressed data set [z_{rough+vib}] obtained at S11. FIG. 19 shows the gray scale version of a false colour image of the vibration-induced surface, that is the vibration data set, [z_{vib}] obtained for the paraboloid surface at S20 whilst FIG. 20 shows a gray scale image of a false colour image of the corrected form-suppressed surface data set [z_{rough}] obtained for the paraboloid surface at S21 in FIG. 6c. FIG. 21 shows initial x and y axis power spectra whilst FIG. 22 shows final x and y axis power spectra for the paraboloid surface. FIGS. 21 and 22 have logarithmic y axis scales. The reduction in the vibration-induced surface power spectra is evident.

FIG. 7a shows a block diagram illustrating another embodiment of the corrected surface data set provider whilst FIG. 7b shows a flow chart illustrating processes carried out by the corrected surface data set provider shown in FIG. 7a.

Referring now to FIGS. 7a and 7b, in this example a generic predictive filtering process is used to suppress vibration-induced phase errors.

In the example shown in FIG. 7a, the form suppressing module provides the same functionality as shown in FIG. 6a and/or as described above with reference to FIG. 6b, as do the adder 116 and the outputter 117, and so these will not be described again.

In the example shown in FIG. 7a, the functionality provided by the harmonic model providing module, the vibration data determining module and the surface roughness determining module is different from that described above with reference to FIGS. 6a and 6c. In particular as will become evident below, the vibration data determining module does not set any ‘bad’ data to zero (or a local mean) and, as a consequence, the surface roughness determining module does not modify the resulting surface roughness values for any such ‘bad’ data locations.

In this example, as shown in FIG. 7a, the harmonic model providing module (120 of FIG. 4) comprises a vibration modeller 401 arranged or configured to model the vibration as a series of harmonics of the fundamental phase of the surface form where those harmonics are modified by a polynomial in x and y (that is an x, y bivariate polynomial or ‘bipolynomial’) where the coefficients of the bivariate polynomial are unknown. In this example, the vibration modeller 401 is arranged or configured to determine the fundamental phase of the form from the form data set [z_{form}] in accordance with equation 1b above.

A vibration data set determiner 402 is arranged or configured to determine the vibration data set [z_{vib}] by setting the harmonic model equal to the ‘good’ data (x,y) locations of the modified form-suppressed data set z_{rough+vib}(x,y), where the ‘good’ data (x,y) locations are the complement of the determined ‘bad’ data (x,y) locations. The vibration data set determiner 402 is arranged or configured to solve the resultant matrix or simultaneous equations for the coefficients of the bipolynomial using a least mean squares approach. Insofar as the vibration effects are concerned, the roughness is, in effect, random and so can be considered as noise and thus be represented by the residual error in a least mean squares approach. A subset of the ‘good’ data, for example every 5^{th} data (x,y) location, may be used instead of the complete ‘good’ data set to increase the computational speed. Once the coefficients of the bivariate polynomial have been determined, then the vibration data set determiner 402 can of course determine the vibration data [z_{vib}] by substituting the determined coefficients into the model.

An example of a generic filtering process that enables suppression of CSI vibration-induced phase errors will now be described with the aid of FIG. 7b. This process or method may, but need not necessarily, use the corrected surface data provider described above with reference to FIG. 7a.

The process proceeds as described above by determining a form-suppressed surface data set as described above with reference to FIG. 6b.

Thus, as described above, the corresponding form, [z_{form}], of the initial surface data set [z_{orig}] (S10 in FIG. 6b) is determined by fitting a surface (such as a 7^{th} order polynomial in x and y) to [z_{orig}] to obtain a form data set [z_{form}] (S11 in FIG. 6b) and the difference between the initial surface data and the form data for each surface pixels determined (S12 in FIG. 6b) to provide an initial form-suppressed surface data set. The form-fitting process may be repeated as described above with reference to FIG. 6b excluding the data locations for which the modulus of [z_{orig}]−[z_{form}] exceeds a standard deviation-based threshold to improve the form fitting and a revised listing of threshold-exceeding ‘bad’ (x,y) locations obtained as discussed above.

The ‘good’ data (x,y) locations (x,y)_{good} are clearly the complement of the ‘bad’ data (x,y) locations. The fundamental phase [Ψ_{form}] of the surface form is determined in accordance with equation 1b above (reproduced in equation 10 below).

At this stage then, in addition to the fitted form [z_{form}], a substantive listing of the residual ‘good’ (x,y) locations is known. For these locations, the residual difference between the form data and the initial surface data set corresponds to a listing, Z_{rough+vib} (x,y), of (x,y) values of the surface roughness and vibration-induced surface features (together with a degree of instrument noise). We therefore have:

$$\begin{matrix}[ {z}_{form} ] \& [ {Ψ}_{form} ] = \frac{4 π}{{λ}_{o}^{′}} [ {z}_{form} ] & 10 ) \\ ⌊ {z}_{rough + vib} ⌋ = ⌊ {z}_{orig} ⌋ - ⌊ {z}_{form} ⌋ \& {( x , y )}_{good} & 11 \text{)}\end{matrix}$$

The vibration-induced harmonics vary over the field of view of the interferometer objective. This variation has the consequence of extending/distorting the amplitude distributions of the harmonics within the Fourier domain. To address this issue, at S23 in FIG. 7b a least mean squares approach is used in which each harmonic is modified by an x,y bivariate polynomial (“bipolynomial”) of given order, n (typically 5), to provide a harmonic model as set out in equation 12) below:

[z_{vib}]=Σ_{h=h min}^{h max}([cos(hΨ_{form})]·Σⱼ₌₀ⁿΣₚ₌₀^{j}aₕⱼₚ[x^{j-p}]·[y^{p}]+[sin(hΨ_{form})]·Σⱼ₌₀ⁿΣₚ₌₀^{j}bₕⱼₚ[x^{j-p}]·[y^{p}]) 12)

Where h is the harmonic order and h ranges between hₘᵢₙ and hₘₐₓ where hₘᵢₙ is the lowest harmonic (typically 0.5) and hₘₐₓ is the highest harmonic (typically the minimum of a user-specified value (typically 6) and double the number of fringes), p is the maximum power in x and y and the unknowns are the ‘a and b’ coefficients of the x,y bipolynomial.

At S24, the vibration model plus an error term is set equal to the form-suppressed data set z_{rough+vib} (x,y) which includes only the ‘good’ data locations.

For the purposes of illustration, herein the number of harmonics and the order of the bipolynomial are both limited to 2 so that

(writing Cₕ₁=cos(hΨ_{from}(x₁,y₁), Sₕ₁=sin(hΨ_{form}(x₁,y₁) for brevity) the equation to be solved can be represented as the matrix equation

$$( \begin{matrix}{C}_{11} & {S}_{11} & {x}_{1} {C}_{11} & {x}_{1} {S}_{11} & {y}_{1} {C}_{11} & {y}_{1} {S}_{11} & {C}_{21} & {S}_{21} & {x}_{1} {C}_{21} & {x}_{1} {S}_{21} & {y}_{1} {C}_{21} & {y}_{1} {S}_{21} \\ {C}_{12} & {S}_{12} & {x}_{2} {C}_{12} & {x}_{2} {S}_{12} & {y}_{2} {C}_{12} & {y}_{2} {S}_{12} & {C}_{22} & {S}_{22} & {x}_{2} {C}_{22} & {x}_{2} {S}_{22} & {y}_{2} {C}_{22} & {y}_{2} {S}_{22} \\ {C}_{13} & {S}_{13} & {x}_{3} {C}_{13} & {x}_{3} {S}_{13} & {y}_{3} {C}_{13} & {y}_{3} {S}_{13} & {C}_{23} & {S}_{23} & {x}_{3} {C}_{23} & {x}_{3} {S}_{23} & {y}_{3} {C}_{23} & {y}_{3} {S}_{23} \\ {C}_{14} & {S}_{14} & {x}_{4} {C}_{14} & {x}_{4} {S}_{14} & {y}_{4} {C}_{14} & {y}_{4} {S}_{14} & {C}_{24} & {S}_{24} & {x}_{4} {C}_{24} & {x}_{4} {S}_{24} & {y}_{3} {C}_{24} & {y}_{4} {S}_{24} \\ {C}_{15} & {S}_{15} & {x}_{5} {C}_{15} & {x}_{5} {S}_{15} & {y}_{5} {C}_{15} & {y}_{5} {S}_{15} & {C}_{25} & {S}_{25} & {x}_{5} {C}_{25} & {x}_{5} {S}_{25} & {y}_{3} {C}_{25} & {y}_{5} {S}_{25} \\ {C}_{16} & {S}_{16} & {x}_{6} {C}_{16} & {x}_{6} {S}_{16} & {y}_{6} {C}_{16} & {y}_{6} {S}_{16} & {C}_{26} & {S}_{26} & {x}_{6} {C}_{26} & {x}_{6} {S}_{26} & {y}_{3} {C}_{26} & {y}_{6} {S}_{26} \\ {C}_{17} & {S}_{17} & {x}_{7} {C}_{17} & {x}_{7} {S}_{17} & {y}_{7} {C}_{17} & {y}_{7} {S}_{17} & {C}_{27} & {S}_{27} & {x}_{7} {C}_{27} & {x}_{7} {S}_{27} & {y}_{3} {C}_{27} & {y}_{7} {S}_{27} \\ {C}_{18} & {S}_{18} & {x}_{8} {C}_{18} & {x}_{8} {S}_{18} & {y}_{8} {C}_{18} & {y}_{8} {S}_{18} & {C}_{28} & {S}_{28} & {x}_{8} {C}_{28} & {x}_{8} {S}_{28} & {y}_{3} {C}_{28} & {y}_{8} {S}_{28} \\ … & … & … & … & … & … & … & … & … & … & … & … \\ … & … & … & … & … & … & … & … & … & … & … & … \\ … & … & … & … & … & … & … & … & … & … & … & …\end{matrix} ) ( \begin{matrix}{a}_{100} \\ {b}_{100} \\ {a}_{110} \\ {b}_{110} \\ {a}_{111} \\ {b}_{111} \\ {a}_{200} \\ {b}_{200} \\ {a}_{210} \\ {b}_{210} \\ {a}_{211} \\ {b}_{211}\end{matrix} ) + ( error ) = ( \begin{matrix}{z}_{rough + vib} ( {x}_{1} , {y}_{1} ) \\ {z}_{rough + vib}^{′} ( {x}_{2} , {y}_{2} ) \\ {z}_{rough + vib} ( {x}_{3} , {y}_{3} ) \\ {z}_{rough + vib} ( {x}_{4} , {y}_{4} ) \\ {z}_{rough + vib} ( {x}_{5} , {y}_{5} ) \\ {z}_{rough + vib} ( {x}_{6} , {y}_{6} ) \\ {z}_{rough + vib} ( {x}_{7} , {y}_{7} ) \\ {z}_{rough + vib} ( {x}_{8} , {y}_{8} ) \\ … \\ … \\ … \\ …\end{matrix} ) \qquad 13 )$$

The simultaneous equations represented by this matrix may be solved for the unknown coefficients a and b using, as set out above, a least squares approach recognising that equation 13) is of the form shown in equation 14) below:

$${f}_{k} = {\sum }_{j = 1}^{m} {A}_{kj} {u}_{j} + {ɛ}_{k} = {z}_{rough + vib} ( {x}_{k} , {y}_{k} ) \qquad 14 )$$

so that

$${\sum }_{k = 1}^{n} {( {ɛ}_{k} )}^{2} = {\sum }_{k = 1}^{n} {( {\sum }_{j = 1}^{m} {A}_{kj} {u}_{j} - {z}_{rough + vib} ( {x}_{k} , {y}_{k} ) )}^{2} \qquad 15 )$$

where Aᵢⱼ represents the matrix and uⱼ the vector in a and b.

Equation 15 can be solved for uⱼ by setting the differentials with respect to unknown components of uⱼ equal to zero.

Thus the large matrix shown in equation 13) effectively accesses and fits the vibration component within Z_{rough+vib}(x,y) Solving the simultaneous equations represented by this matrix at S24 in FIG. 7b using a least mean squares approach allows the ‘a and b’ coefficients to be determined and thus allows the vibration-induced surface, [z_{vib}], to be determined in accordance with equation 16) below:

[z_{vib}]=(a₁₀₀+a₁₁₀[x]+a₁₁₁[y])·[cos(Ψ_{form})]+((b₁₀₀+b₁₁₀[x]+b₁₁₁[y])·[sin(Ψ_{form})])+(a₂₀₀+a₂₁₀[x]+a₂₁₁[y])·[cos(2Ψ_{form})]+((b₂₀₀+b₂₁₀[y])·[sin(2Ψ_{form})]) 16)

Finally, the surface roughness is extracted and then added to the form to generate the corrected surface. Thus; at S25 in FIG. 7b, a surface roughness data set [z_{rough}] is obtained by subtracting the vibration data value obtained for each surface pixel from the corresponding value in the form-suppressed surface data set as shown in equation 7) reproduced below:

[z_{rough}]=[z_{rough+vib}]−[z_{vib}] 7)

Any ‘bad’ data locations therefore remain the same apart from being compensated for vibration.

Then at S26, for each surface pixel, the roughness data value is added to the corresponding value in the form data set to obtain a corrected surface data set representing the corrected surface as shown in equation 9) reproduced below:

[z_{final}]=[z_{form}]+[z_{rough}] 9)

It will, of course, be appreciated that the number of harmonics and the order of the bipolynomial have been limited to 2 in the matrix shown in equation 13 for the purposes of illustration and that, in practice, the number of harmonics and the order of the bipolynomial may be greater than 2. Typical values for hₘₐₓ and the polynomial order respectively being the minimum of 6 and double the fringe number, and 5.

The process described above with reference to FIG. 7b enables suppression of vibration-induced phase errors even in cases where the Fourier transform of the form-based harmonics is not relatively localised, that is in cases where the surface under test does not have directionality. The process described above with reference to FIG. 7b is suited to any ‘free-form’ surface but is computationally more intensive and so not such a fast process as that described above with reference to FIG. 6c.

FIGS. 23 to 34 illustrate the carrying out of the generic process described above by reference to FIGS. 6b and 7b on an initial surface data set representing the results of a measurement by a coherence scanning interferometer (CSI) of a surface area of two surfaces, one being a paraboloid and the other a tilted flat, both measured with a x10 objective.

FIGS. 23 to 26 and 29 to 32 are gray scale versions of original false colour images in which relative surface heights are represented by different colours. The scale to the right in FIGS. 23, 24, 26, 29, 30 and 32 indicates the relationship between the colour in the false colour image and the surface height in micrometres (μm).

FIGS. 23 to 28 show the results on an initial surface data set where the initial surface was a paraboloid. FIG. 23 shows the gray scale version of a false colour image of the initial surface height data set [z_{orig}] whilst FIG. 24 shows the gray scale version of a false colour image of the initial paraboloid surface data set shown in FIG. 23 with form suppressed, that is FIG. 24 shows the form-suppressed data set [z_{rough+vib}] obtained at S11. FIG. 25 shows a gray scale image of a false colour image of a vibration induced surface [z_{vib}] as modelled by the harmonic model as set out in equation 13) whilst FIG. 26 shows a gray scale image of a false colour image of the corrected form-suppressed surface data set [z_{rough}] obtained for the paraboloid surface at S25 in FIG. 7b. FIG. 27 shows initial x and y axis power spectra whilst FIG. 28 shows final x and y axis power spectra for the hyperboloid surface. FIGS. 27 and 28 have logarithmic y axis scales. The reduction in the vibration-induced surface power spectra is evident.

FIGS. 29 to 34 show the results on an initial surface data set where the initial surface was a tilted flat. FIG. 29 shows the gray scale version of a false colour image of the initial surface height data set [z_{orig}] whilst FIG. 30 shows the gray scale version of a false colour image of the initial tilted flat surface data set shown in FIG. 29 with form suppressed, that is FIG. 30 shows the form-suppressed data set [z_{rough+vib}] obtained at S11. FIG. 31 shows a gray scale image of a false colour image of a vibration induced surface [z_{vib}] as modelled by the harmonic model as set out in equation 13) whilst FIG. 32 shows a gray scale image of a false colour image of the corrected form-suppressed surface data set [z_{rough}] obtained for the tilted flat surface at S25 in FIG. 7b. FIG. 33 shows initial x and y axis power spectra whilst FIG. 34 shows final x and y axis power spectra for the tilted flat surface. FIGS. 33 and 34 have logarithmic y axis scales. The reduction in the vibration-induced surface power spectra is evident.

### Modifications

In examples described above, a thresholding process is used to remove outlying data which may be ‘bad’ data resulting from, for example, surface debris. In some circumstances, this process may be omitted, for example, if the surface can be considered clear of debris, although care should be taken if omitting this process because, as mentioned above, surface height modulation induced by microscopic debris and surface contaminant-induced ‘fringe order’ errors is typically some 3 orders of magnitude greater than the vibration-induced topographical modulation.

The form suppressing module 100 may configured or arranged to refine the determination of the form-suppressed data set, [z_{rough+vib}], and the form data set, [z_{form}], by repeating the fitting process excluding the ‘bad’ data (x,y) locations to refine [z_{form}]. In order to achieve high fidelity form-fitting, the more iterations of the form-fitting and then threshold-based data exclusion procedure are carried out the better.

In the embodiments described with reference to FIGS. 6a and 6c the form-suppressed surface data set from which the vibration data set is removed will generally be the modified form-removed surface data set in which the data for tad' data locations has been modified as per equation 8. However, the form-suppressed surface data set in which any ‘bad’ data locations have been set to zero (or to a local mean) could be used or perhaps the initial form-suppressed surface data set could be used.

It will, of course, be appreciated that the number of harmonics and the order of any polynomials may be different from those given above. Any appropriate number of harmonics and any appropriate order of polynomial or bipolynomial may be used.

The x and y order of the polynomials may be chosen to differ, particularly in circumstances where there is a significantly different fringe density substantially in these two directions. Thus, for example, equation 12 may be replaced by

[z_{vib}]=Σ_{h=h min}^{h max}([cos(hΨ_{form})]·Σⱼ₌₀ⁿΣₚ₌₀^{ĵ}aₕⱼₚ[x^{j-p}]·[y^{p}]+[sin(hΨ_{form})]·Σⱼ₌₀ⁿΣₚ₌₀^{ĵ}bₕⱼₚ[x^{j-p}]·[y^{p}]) 12a)

where ĵ=min(j,jₘₐₓ)

hₘᵢₙ is the lowest harmonic and hₘₐₓ is the highest harmonic, and

where jₘₐₓ is the maximum power in y and n is the maximum power in x

and which incorporates x,y bipolynomials of the form x¹y^{m} where 0≦m≦jₘₐₓ

Generally, the vibration data is dominated by even harmonics. In the examples given above the harmonic model uses harmonics up to the 6th order. Higher order harmonics may be included but generally the amplitude of the harmonics drops off fairly rapidly with order to the extent that the harmonics beyond the second order are usually small and so incorporating up to the 6^{th} order should be sufficient. It may also be possible to use only up to the 4^{th} order harmonics. For many situations, the harmonics that dominate are the very low even harmonics so exclusion of at least one and possibly both of the ‘half’ harmonic and the odd harmonics is a realistic approach.

As another possibility, in the embodiment described above with reference to FIGS. 6a and 6c the surface roughness data set [z_{rough}] may be obtained directly by determining the 2D inverse Fourier transform of the Fourier transform of the form-suppressed data set [z_{rough+vib}] multiplied by the complement of the window, W, without explicitly evaluating the vibration data set [z_{vib}]. In this case the vibration data remover and vibration data set store shown in FIG. 6a are not required and the remaining functionality of the vibration data determiner (the frequency transformer 111, window determiner 112 and window applier 113 (in this case the window's complement applier) and the inverse frequency transformer 114) may be provided by the surface roughness determiner with the result provided by the inverse frequency transformer 114 being stored in the surface roughness data set store 208.

As described above, Fourier analysis is used. Other forms of frequency transform procedures such as the Hartley transform may be used.

As described above a generic surface (defined by the 2D polynomial) is used in the form fitting process. Generally, the type of the form (for example spherical, paraboloid, and hyperboloid) will be known and accordingly the form-fitting process may use a surface of that known type to fit the form which may increase computational speed. As another possibility, where the form is not known, specific types of fitting surface (sphere, paraboloid, hyperboloid, optical flat) may be tried one after another and the fitting surface that has the closest fit to the measured surface may then be chosen. The form fitting procedure should of course be determined so as to avoid or at least reduce the possibility of including some of the low order vibration-induced components.

It should be appreciated that the form fitting process may or may not remove all of the form: the form-suppressed data set may simply be a form-suppressed data set in which any residual form is swamped by surface roughness.

Also different weighting functions for the synthetic multi-harmonic surface than those set out above may be used. In addition, the thresholding process may use any appropriate technique to determine the outlying or ‘bad’ data points.

As described above the harmonics correspond to positive frequencies. This need not necessarily be the case, harmonics corresponding to negative frequencies could be used in either of the embodiments described above. In the case of the embodiment described with reference to FIGS. 6a and 6c corresponding modification of the weighting function, w(h), would be required.

As described above with reference to FIG. 6c, the values at any ‘bad’ data (x,y) locations may be set equal to zero. As another possibility, the bad data (x,y) locations may be set to data values determined by the data values of a subset of the ‘good data’ (x,y) locations of z_{rough+vib}(x,y), for example any the bad location data value may be replaced with an average of the data values of surrounding ‘good data’ (x,y) locations (adjacent surface pixels), that is a local average value.

Where the ‘bad’ data (x,y) locations are set equal to zero, then as described above, to maintain the fidelity of the original measurement, for any ‘bad’ data (x,y) locations, the determined local roughness value z_{rough} (x,y) in the surface roughness data set [z_{rough}] may be modified by adding the difference zᵢₙᵢₜᵢₐₗ(x,y)−z_{form}(x,y) thus completing the data set [z_{rough}]. This modification may also be effected where any bad location data value is replaced with a local average value.

In the above described examples, the data for individual surface pixels (that is the portion of a surface image by a single sensing element) is analysed. In some examples, the data for individual surface pixels may be binned or combined before analysis. Such binning is standard practice in coherence scanning interferometry and in this context its most relevant effect is the generation of larger effective pixels.

In the above described examples, the initial surface data set is obtained by a coherence scanning interferometer. The processes or methods described above may also be applied where the initial surface data set is obtained by other techniques such as PSI.

In the examples and embodiments described above, the data processor is implemented by a computing apparatus. It will, of course, be understood that one or more computing apparatus may be used and that such computing apparatus may or may not be physically separated. In addition, it may be possible to implement the described examples and embodiments by use of hard-wired circuitry and one or more digital signal processors (DSPs), for example.

The functionality provided by the data processor need not necessarily be provided by one physical entity (for example computing apparatus). As an example, the initial surface data set provider and the corrected surface data set provider may be provided by physically separate entities which may be located at the same or different locations. Different functionality of the corrected surface data set provider may be provided by physically separate entities which may be located at the same or different locations. Separate physical entities may be connected by a wireless or wired link or via a network such as the Internet, an intranet, a WAN or LAN, for example. It should also be appreciated that the modules and functional blocks are shown in the Figures for the purposes of illustration and do not necessarily imply that the functionality is so divided. Thus, it should be understood that the functional block diagrams are intended simply to show the functionality that exists and should not be taken to imply that each block shown in the functional block diagram is necessarily a discrete or separate entity. The functionality provided by a block may be discrete or may be dispersed throughout the apparatus or throughout a part of the apparatus. In addition, the functionality may incorporate, where appropriate, hard-wired elements, software elements or firmware elements or any combination of these.

The present invention also provides a computer program product to program computing apparatus to provide the data processor shown in FIG. 1 or to provide one or both of the initial surface data set provider and corrected surface data set provider described above, or to provide any functionality of the corrected surface data set provider described above. Computing apparatus may be programmed by program instructions provided by any one or more of: downloaded from a non-transitory data carrier such as a CDROM, DVD, memory stick or the like; downloaded as a signal from another computing apparatus, for example over a network, via a wireless or wired link; input by a user using the user interface.

1. A metrological apparatus for determining a surface characteristic of a surface of a workpiece, the metrological apparatus comprising:
a surface data determiner to determine from measurement data a measured surface roughness data set representing measured surface roughness and including any vibration induced measurement error;
a harmonic model provider providing a harmonic model representing vibration-induced surface characteristics of the surface as a set of harmonic components selected based on a surface form of the surface of the workpiece;
a surface roughness determiner to use the harmonic model and the measured surface roughness data to obtain a modified surface roughness data set in which vibration induced measurement error is suppressed.

2. A metrological apparatus according to claim 1, wherein the harmonic model provider is configured to provide a harmonic model representing vibration-induced surface characteristics of the surface as a set or series of weighted or modified harmonic components.

3. (canceled)

4. A metrological apparatus according to claim 1, wherein the harmonic model provider is configured to model vibration-induced surface characteristics of the surface as a synthetic surface comprising set of weighted harmonic components in accordance with
[z_{synth}]=Σ_{h=h min}^{h max}w(h)[cos(hΨ_{form})]
where w(h) is a weighting function
where Ψ_{form} is the phase of the form of the surface
where h ranges between hₘᵢₙ and hₘₐₓ where hₘᵢₙ is the lowest harmonic and hₘₐₓ is the highest harmonic.

5. A metrological apparatus according to claim 4, wherein the harmonic model provider is configured to use a weighting function w(h) of the form
w(½)=0.25
w(h)=exp(A·exp(Bh))
where A and B are dimensionless constants.

6. A metrological apparatus according to claim 1, further comprising
a vibration data determiner to determine vibration data using the measured surface roughness data set and the harmonic model and wherein the surface roughness determiner is arranged to determine the modified surface roughness data set by subtracting the vibration data from the measured surface roughness data.

7. A metrological apparatus according to claim 6, wherein the vibration data provider is configured to determine a frequency domain window using the harmonic model, to apply the window to a frequency transform of the measured surface roughness data set to obtain windowed frequency transform data and to determine an inverse of the windowed frequency transform data to provide the vibration data.

8. A metrological apparatus according to claim 1, wherein the surface roughness determiner is configured to determine a frequency domain window using the harmonic model, to apply the complement of the window to a frequency transform of the measured surface roughness data set to obtain windowed frequency transform data and to determine an inverse of the windowed frequency transform data to provide the modified surface roughness data set.

9. (canceled)

10. A metrological apparatus according to claim 1, wherein the harmonic model provider is configured to model vibration-induced surface characteristics of the surface as a synthetic surface comprising harmonic components, a vibration data provider is configured to apply a frequency transform to the synthetic surface to define a window, to apply the window to a frequency transform of the measured surface roughness data set to obtain windowed frequency transform data and then to determine an inverse of the windowed frequency transform data to provide vibration data, and wherein the surface roughness determiner is arranged to determine the modified surface roughness data set by subtracting the vibration data from the measured surface roughness data.

11. A metrological apparatus according to claim 1, wherein the harmonic model provider is configured to model vibration-induced surface characteristics of the surface as a synthetic surface comprising a set of weighted harmonic components in accordance with:
[z_{synth}]=Σ_{h=h min}^{h max}w(h)[cos(hΨ_{form})]
where w(h) is a weighting function
where Ψ_{from} is the phase of the form of the surface
where h ranges between hₘᵢₙ and hₘₐₓ where hₘᵢₙ is the lowest harmonic and hₘₐₓ is the highest harmonic;
a vibration data determiner is provided:
to determine a frequency transform of the harmonic model in accordance with
[Wₚ]=|ℑ_{x,y}([z_{synth}])|;
to define a window, W, as being zero, or unity where the modulus of the frequency transform components is above a threshold;
to apply the window to a frequency transform of the measured surface roughness data set; and
to determine a vibration data set in accordance with
[z_{vib}]=ℑ⁻¹_{fx,fy}([W],ℑ_{x,y}([z_{rough+vib}])).
Where z_{[rough+vib}] is the measured surface roughness data set; and
wherein the surface roughness determiner is arranged to determine the modified surface roughness data set by subtracting the vibration data from the measured surface roughness data.

12. (canceled)

13. A metrological apparatus according to claim 1, wherein the harmonic model provider is configured to model vibration-induced surface characteristics as a harmonic model comprising a sum of harmonics modified by a polynomial having unknown coefficients, wherein the apparatus comprises a vibration data determiner to determine the vibration data by relating the harmonic model to the measured surface roughness data set and then solving for the coefficients of the polynomial, and wherein the surface roughness determiner is arranged to determine the modified surface roughness data set by subtracting the vibration data from the measured surface roughness data.

14. A metrological apparatus according to claim 1, wherein the harmonic model provider is configured to provide a harmonic model representing vibration-induced surface characteristics of the surface as a set harmonic components modified by a polynomial modifier having coefficients and the vibration data determiner is configured to determine the coefficients using a least mean squares approach in which the surface roughness is treated as a residual or error.

15-16. (canceled)

17. A metrological apparatus according to claim 1, wherein the harmonic model provider is configured to model the vibration-induced surface characteristics as a harmonic model comprising a sum of harmonics modified by a polynomial in x and y having unknown coefficients a and b in accordance with:
[z_{vib}]=Σ_{h=h min}^{h max}([cos(hΨ_{form})]·Σⱼ₌₀ⁿΣₚ₌₀^{ĵ}aₕⱼₚ[x^{j-p}]·[y^{p}]+[sin(hΨ_{form})]·Σⱼ₌₀ⁿΣₚ₌₀^{ĵ}bₕⱼₚ[x^{j-p}]·[y^{p}]) 12a)
where ĵ=min(j,jₘₐₓ)
Ψ_{form} is the phase of the form of the surface
and where jₘₐₓ is the maximum power in y and n is the maximum power in x,
wherein the apparatus comprises a vibration data determiner configured to determine vibration data by relating the harmonic model to the measured surface roughness data set and then determining the coefficients of the polynomial using a least mean squares approach in which the surface roughness is treated as a residual or error, and wherein the surface roughness determiner is arranged to determine the modified surface roughness data set by subtracting the vibration data from the measured surface roughness data.

18. A metrological apparatus according to claim 1, wherein the surface data determiner is configured to receive a measurement data set comprising data representing the relative heights of different surface portions of a surface area and wherein the surface data determiner comprises a surface form suppressor configured to carry out a form fitting process to determine from the received measurement data set a form of the surface to provide a form data set and to remove the determined form from the measurement data set to provide the measured surface roughness data set as a form-suppressed data set.

19. A metrological apparatus according to claim 18, wherein the surface form suppressor comprises a thresholder configured to determine a difference between the measurement data set and the form data set and to identify the location of any data where the difference exceeds a threshold.

20. A metrological apparatus according to claim 19, wherein the surface form suppressor is configured to repeat the form fitting process excluding any locations where the difference exceeds a threshold so as to refine the determination of the form of the surface and then to remove the refined form from the measurement data set to provide the form-suppressed data set.

21. A metrological apparatus according to claim 19 wherein form-suppressed data set is modified to adjust the data for any locations where said difference exceeds the threshold to provide the measured surface roughness data for use by the surface roughness determiner.

22.-24. (canceled)

25. A metrological apparatus according to claim 24, further comprising an adder to add, for each surface portion, the modified surface roughness data to the form data to obtain a modified surface data set.

26. A metrological apparatus according to claim 1, wherein the harmonic model provider is configured to select the set of harmonic components based on a phase of the form of the surface determined in accordance with
$$[ {Ψ}_{form} ] = \frac{4 π}{{λ}_{o}^{′}} [ {z}_{form} ]$$
where [z_{form}] is a data set representing the form and λ′₀ is the mean effective wavelength which is defined such that, if for a given (x,y) pixel location, the relative height of the local surface with respect to the reference surface changes by λ′₀/8, the interference phase changes by 90°.

27.-28. (canceled)

29. A data processor for determining a surface characteristic of a surface of a workpiece, the data processor being configured:
to determine from measurement data a measured surface roughness data set representing measured surface roughness;
to provide a harmonic model representing vibration-induced surface characteristics of the surface as a set of harmonic components selected based on a form of the surface of the workpiece;
to determine a modified surface roughness data set using the harmonic model and the measured surface roughness data to obtain a modified surface roughness data set in which vibration induced measurement error is suppressed.

30.-54. (canceled)

55. A method of determining a surface characteristic of a surface of a workpiece, the method comprising:
determining from measurement data a measured surface roughness data set representing measured surface roughness and including any vibration induced measurement error;
providing a harmonic model representing vibration-induced surface characteristics of the surface as a set of harmonic components selected based on a form of the surface of the workpiece;
using the measured surface roughness data set and the harmonic model to obtain a modified surface roughness data set in which vibration induced measurement error is suppressed; and
outputting the modified surface roughness data set.

56.-83. (canceled)

84. A non-transitory computer program product storing program instructions that when executed by computing apparatus cause the computing apparatus to:
determine from measurement data a measured surface roughness data set representing measured surface roughness and including any vibration induced measurement error;
provide a harmonic model representing vibration-induced surface characteristics of the surface as a set of harmonic components selected based on a form of the surface of the workpiece;
use the measured surface roughness data set and the harmonic model to obtain a modified surface roughness data set in which vibration induced measurement error is suppressed; and
output the modified surface roughness data set.

85. (canceled)
